(19) United States
(12) Patent Application Publication
(10) Pub. No.: US 2018/0336554 A1
(43) Pub. Date: Nov. 22, 2018

(54) SECURE ELECTRONIC TRANSACTION AUTHENTICATION

(71) Applicant: Douglas H. TROTTER, Baltimore, MD (US)

(72) Inventor: Douglas H. TROTTER, Baltimore, MD (US)

(21) Appl. No.: 15/981,312

(22) Filed: May 16, 2018

Related U.S. Application Data
(60) Provisional application No. 62/603,622, filed on May 17, 2017.

(51) Int. Cl. G06Q 20/38; G06Q 20/40; G06F 21/34; G06F 21/32; G06F 21/62; H04L 9/32; H04L 29/06; G06F 9/455

(52) U.S. Cl. CPC G06Q 20/3823; G06Q 20/40145; G06Q 20/3829; G06F 21/34; G06F 21/32; G06F 9/45558; H04L 9/3213; H04L 9/3247; H04L 9/3231; H04L 63/107; G06F 21/62

(57) ABSTRACT

Systems and methods for a secure electronic transaction system are presented that includes a hardware based token that includes a manufactured identity key. The system and methods also use a public/private key pair that is linked to a user and the hardware based token. Further, a policy server is communicatively coupled to the hardware based token. The hardware based token contains biometric identification data of the user and the policy server is used to provide authentication of the user based on a number of factors. Those factors include possession of the hardware based token by the user, a matching of the manufactured identity key with a priori registered key stored on the policy server, the public/private key pair; a user password, and the biometric identification data.

### CROSS REFERENCE TO RELATED APPLICATIONS

This application is a non-provisional application that claims the benefit of U.S. provisional Application No. 62/603,622, filed on May 17, 2017, the contents of which are herein incorporated by reference in their entirety.

### FIELD

This invention relates to a computerized system using multi-level authentication with a federated identity model.

### BACKGROUND

Over at least the past decade, electronic commerce finds much of its momentum in the dogged pursuit of achieving a single, critical objective, namely the ability to create a secure, trusted environment that protects information throughout the entire process. Companies have spent hundreds of millions of dollars in cyber security products to insure that their systems and electronic networks protect their most sensitive business information with their suppliers, partners and customers. Nevertheless, the essential business transactions are unprotected and continue to be at risk of being compromised placing any business in peril. To date, all of the innovations in electronic commerce have failed to deliver what businesses and governments truly require—a secure, comprehensive and integrated solution for executing electronic transactions in which the transactions are secure and identified to its true owner. To succeed, the solution must be simple, the results must be legally effective and the documents and processes must be attributable to an individual that are authentic—a requirement of all transaction based systems.

### BRIEF SUMMARY

Given the foregoing, what is needed is a system and method for a fully integrated transaction system that delivers the trusted means for producing electronic transactions that are unique, secure and reliable for all business and legal purposes.

In an embodiment of the present disclosure, a secure electronic transaction system is presented that includes a hardware based token that includes a manufactured identity key. The system also uses a public/private key pair that is linked to a user and the hardware based token. Further, a policy server is communicatively coupled to the hardware based token. The hardware based token contains biometric identification data of the user and the policy server is used to provide authentication of the user based on a number of factors. Those factors include possession of the hardware based token by the user, a matching of the manufactured identity key with a priori registered key stored on the policy server, the public/private key pair, a user password, and the biometric identification data.

In an embodiment of the present disclosure, a method is disclosed that includes communicatively coupling a hardware based token with a policy server, where the hardware based token contains a manufactured identity key. The method includes receiving, by the policy server, the manufactured identity key and a public/private key pair that is linked to a user and the hardware based token. The method includes authenticating the user based on multiple factors. Those factors include possession of the hardware based token by the user, a matching of the manufactured identity key with a priori registered key stored on the policy server, the public/private key pair, a user password, and biometric identification data of the user.

Further features and advantages of the present disclosure, as well as the structure and operation of various embodiments of the present disclosure, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the present invention and to enable a person skilled in the relevant art(s) to make and use the present invention.

Additionally, the left-most digit of a reference number identifies the drawing in which the reference number first appears (e.g., a reference number “310” indicates that the element so numbered is first labeled or first appears in FIG. 3). Additionally, elements which have the same reference number, followed by a different letter of the alphabet or other distinctive marking (e.g., an apostrophe), indicate elements which are the same in structure, operation, or form but may be identified as being in different locations in space or recurring at different points in time (e.g., reference numbers ‘110a’ and ‘110b’ may indicate two different energy detection devices which are functionally the same, but are located at different points in a simulation arena).

FIG. 1 is a block diagram of a computer server or system in accordance with embodiments that can implement any of the disclosed components herein.

FIG. 2 depicts a federated identity system in conjunction with a multi-level authentication system, according to an embodiment of the present disclosure.

FIG. 3 depicts an internet based trusted system platform, according to an embodiment of the present disclosure.

FIG. 4 depicts a hardware based token, according to an embodiment of the present disclosure.

FIG. 5 depicts a communication channel security system, according to an embodiment of the present disclosure.

FIG. 6 depicts an electronic policy server based trusted system platform, according to an embodiment of the present disclosure.

FIG. 7 depicts an electronic policy server based trusted system platform using a global positioning system for ongoing authentication, according to an embodiment of the present disclosure.

FIG. 8 depicts an electronic policy server based trusted system platform with a registration authority, according to an embodiment of the present disclosure.

FIG. 9 depicts a flowchart of a method of multi-level authentication using a hardware based token, according to an embodiment of the present disclosure.

FIG. 10 depicts an architectural solution in healthcare, according to an embodiment of the present disclosure.

FIG. 11 illustrated logical relationships between logical data sources on a trusted card/token, according to an embodiment of the present disclosure.

FIG. 12 illustrates an internet centric trusted medical system, according to an embodiment of the present disclosure.

FIG. 13 depicts a policy server centric trusted medical system, according to an embodiment of the present disclosure.

FIG. 14 depicts a home healthcare trusted medical system, according to an embodiment of the present disclosure.

Further embodiments, features, and advantages of the present invention, as well as the operation of the various embodiments of the present invention, are described below with reference to the accompanying figures.

### DETAILED DESCRIPTION OF THE INVENTION

While embodiments described herein are illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The embodiments described herein are referred in the specification as “one embodiment,” “an embodiment,” “an example embodiment,” etc. These references indicate that the embodiment(s) described can include a particular feature, structure, or characteristic, but every embodiment does not necessarily include every described feature, structure, or characteristic. Further, when a particular feature, structure, or characteristic is described in connection with an embodiment, it is understood that it is within the knowledge of one skilled in the art to affect such feature, structure, or characteristic in connection with other embodiments whether or not explicitly described.

The present application relates generally to multi-level authentication for electronic transactions. The multi-level authentication system is also referred to as the “Trusted System” or as a “Trusted System Platform” and is used interchangeably throughout this application.

The Trusted System provides an underlying technology platform upon which specific applications can be developed, e.g., Medical, Voting, Cyber Security, Trading Platforms. The disclosed Trusted Systems are based upon an information technology framework that is used to manage, classify, protect and control valuable digital content and data, thus enabling collaboration across multiple enterprises. Embodiments of the Trusted System use a device such as a USB device, smartphone, tablet or any other portable electronic device that includes a SD Chip or Micro Chip with a manufactured identity key that functions as an identity key to sophisticated cloud based services. The manufactured identity key exists prior to having the hardware based token assigned to a user. The Trusted System includes an integrated system using a virtual machine environment, e.g., Java Virtual Machine, on a dedicated token that is connected to a Policy Server working as a federated, bifurcated, identification/control service, which produces the key to sophisticated cloud-based content control services. An embodiment of the Trusted System is built on five technical pillars: (1) the existence of an online Federated Identity Model, (2) the Java Virtual Machine, (3) multi-gigabyte token containing a unique serial number in the controller, (3) modern cryptography and (4) the ubiquity of the Internet controlled by a Federated Identity Model Management Contract Infrastructure.

The Trusted System uses content generation software that creates customized content for each token produced. This enables the production of an individualized token for each recipient. This means that the token can be tied to the encrypted serial number registered through a federated policy model making it almost impossible to forge. This gives the Trusted System the strength of multifactor authentication, positive identity management and customized content control for the user.

A Trusted System Client Application avoids the need for cumbersome plug-ins providing near-ubiquitous support for all-known content formats and applications. The Client Application is nearly transparent to the end user and has minimal impact on existing content creation and distribution processes.

The Trusted System Client Application runs on a personal computer, tablet, smart device or other electronic device at the device's operating system level, observing the actions of the user and applying appropriate and persistent security. The product ensures that decryption is temporary, holding the decrypted file in a strong secure area that no unauthorized person can access. Additionally, the system enforces the access control rules based on the grants given to that user for that specific file.

The Trusted System constructs a trusted networked community, providing transparent management of keys and encryption methods. The product provides a unique streamlined provisioning process, embracing security structures and ensuring proper authentication of users.

The Trusted System provides a structured and simplified process of capturing security policies that are generated in concert with the Federated Identity Model. This process implements a robust data trust model, allowing Information Technology and business administrators to define the relationship and privileges that should be applied when users access specific types of data.

The Trusted System examines the content and context of data that is being prepared for secure distribution, comparing these results against security templates tailored for the organization and to multiple enterprises, enabling actionable auditing and alert functionality. While preparing content for secure distribution, the system provides the user with specific recommendations on what level of security to apply to that content. The comparison may also trigger security that is based on explicit rules, ensuring stopgap measures for highly sensitive data. The system captures a thorough audit trail of all user-initiated data protection and consumption actions for extended business intelligence and possible breach forensics analysis.

### Architectural Components

Federated Identity Model: A federated identity in the Trusted System is the means of linking a person's/organization's electronic identity and attributes, stored in the policy server that allows access across multiple distinct systems.

Hardware Based Token: A Trusted System Token can be an electronic device that contains a USB Chip, Microchip, SD Chip or any controlled device that has partition memory that will run the a virtual machine, e.g., Java Virtual Machine, above the application layer of the Internet (e.g.: Samsung Galaxy Devices running the Android Operating System and using Samsung's Knox platform).

A trusted policy server uses a virtual machine, hypertext markup language (HTML), extensible markup language (XML) and a database. In an embodiment, the Java Virtual Machine operates on the token that is supported by Windows, Linux and Macintosh operating systems and Java Standard Edition libraries are used. No operating system dependent libraries are permitted for development of software on the token. HTML can also be used because it is ubiquitous technology that can be executed on many different browsers and application software. Related technologies such as JavaScript, Cascading Style Sheets and Dynamic HTML are also permitted when required by the deployment. The use of XML for data structure definition and possible reporting when combined with XSLT is allowed. Certain industry-specific XML libraries can be permitted for compliance, data import, data export or integration. All data export is typically done using XML. Structured data is stored in a database on the token. The database engine can be a multi-user relational database with a small footprint that runs on a platform such as JavaSE and JavaEE. The database can also operate in an embedded mode or in a stand-alone mode that is fully ACID (Atomicity, Consistency, Isolation, and Durability) compliant. The system also supports database encryption and crash recovery

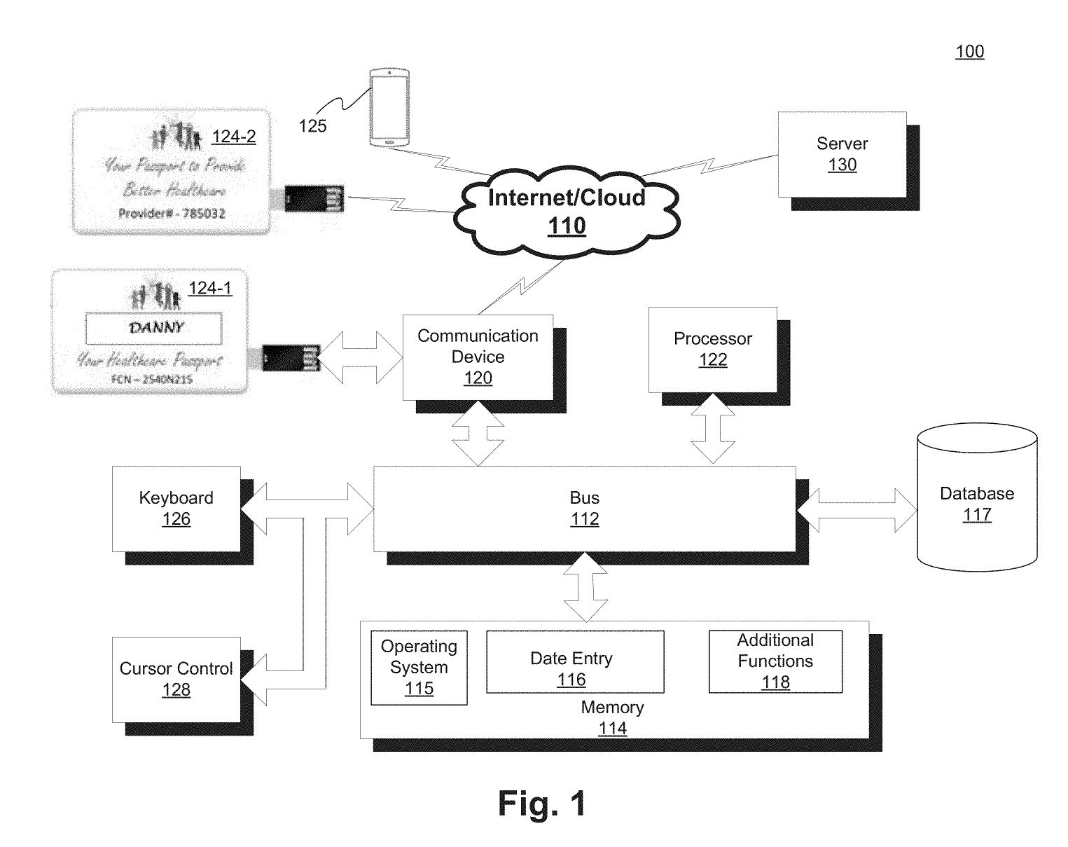

FIG. 1 is a block diagram of a computer server system 100 in accordance with embodiments that can implement any of the disclosed components herein. As shown in FIG. 1, computer server system 100 may include a bus 112 and/or other communication mechanism(s) configured to communicate information between the various components of computer server system 100, such as a processor 122 and a memory 114. In addition, a communication device 120 may enable connectivity between processor 122 and other devices by encoding data to be sent from processor 122 to another device over a network, such as Internet/cloud 110, and decoding data received from another system over the network for processor 122. Processor 122 may also communicate with devices such as a hardware token 124-1 directly through communication device 120, or via Internet/cloud 110 to hardware token 124-2.

In another example, communication device 120 may include a network interface card that is configured to provide wireless network communications. A variety of wireless communication techniques may be used including infrared, radio, Bluetooth®, Wi-Fi, and/or cellular communications. Alternatively, communication device 120 may be configured to provide wired network connection(s), such as an Ethernet connection.

In one embodiment, computer server system 100 includes processor 122 and other components communicating through Internet/cloud 110, or any other communication medium, to an electronic device such as a smartphone, tablet, etc. User device 125 can be any type of device that includes a user interface that enables interaction by a user. User device 125 may include device drivers that enable software applications to interface with hardware devices. In an example embodiment of a mobile device having a touch screen, the mobile device may include a device driver to recognize and translate user input gestures into commands or signals capable of being used by applications. An input device interface may interface with the touch screen device driver of the mobile device to receive user touch screen gestures. User device 125 also includes its own processor, memory, etc. In one embodiment, user device 125 implements a browser and communicates using Hypertext Markup Language (“HTML”) to the remainder of computer server system 100, which functions as a web server and provides web pages to user device 125 either directly or indirectly (i.e., through communication with one or more other web servers). In another embodiment, user device 125 communicates with server 130 that can also function as a web server and storage medium that provides data and/or web pages to user device 125. Any of the communications can also be encrypted such as an encrypted cloud connection or an encrypted Internet connection.

Processor 122 may include one or more general or specific purpose processors to perform computation and control functions of computer server system 100. Processor 122 may include a single integrated circuit, such as a micro processing device, or may include multiple integrated circuit devices and/or circuit boards working in cooperation to accomplish the functions of processor 122. In addition, processor 122 may execute computer programs, such as an operating system 115, a data entry module 116, and application 118, stored within memory 114.

Computer server system 100 may include memory 114 for storing information and instructions for execution by processor 122. Memory 114 may contain various components for retrieving, presenting, modifying, and storing data. For example, memory 114 may store software modules that provide functionality when executed by processor 122. The modules may include an operating system 115 that provides operating system functionality for computer server system 100. The modules can include an operating system 115, data entry module 116 configured to provide data entry via a user interface, and all other functionality disclosed herein, as well as other additional functionality modules, such as application 118.

Memory 114, being non-transitory, may include a variety of computer-readable medium that may be accessed by processor 122. For example, memory 114 may include any combination of random access memory (“RAM”), dynamic RAM (“DRAM”), static RAM (“SRAM”), read only memory (“ROM”), flash memory, cache memory, and/or any other type of non-transitory computer-readable medium.

The web server portion of computer server system 100 may further include a keyboard 126 and a cursor control device 128, such as a computer mouse, to enable a user to interface with computer server system 100. Computer server system 100 further may include a database 117 coupled to bus 112 to provide centralized storage for data entry module 116 and application 118 and to store, for example, Point Of Service data as well as data for displaying the UI widget for date entry, customer data, etc. Database 117 can store data in an integrated collection of logically-related records or files. Database 117 can be an operational database, an analytical database, a data warehouse, a distributed database, an end-user database, an external database, a navigational database, an in-memory database, a document-oriented database, a real-time database, a relational database, an object-oriented database, or any other database known in the art. Further, any or all of the databases can be an encrypted database.

Although shown as a single system, the functionality of computer server system 100 may be implemented as a distributed system. For example, memory 114 and processor 122 may be distributed across multiple different computers that collectively make up computer server system 100. As previously disclosed, user device 125 is generally a mobile device that is remotely located from the remainder of computer server system 100, which functions as a web server. Further, one or more components of computer server system 100 may not be included. For example, for functionality as a user or consumer device, computer server system 100 may be a smartphone or other wireless device that includes a processor, memory, and a display, does not include one or more of the other components shown in FIG. 1, and includes additional components not shown in FIG. 1, such as an antenna, transceiver, or any other suitable wireless device component.

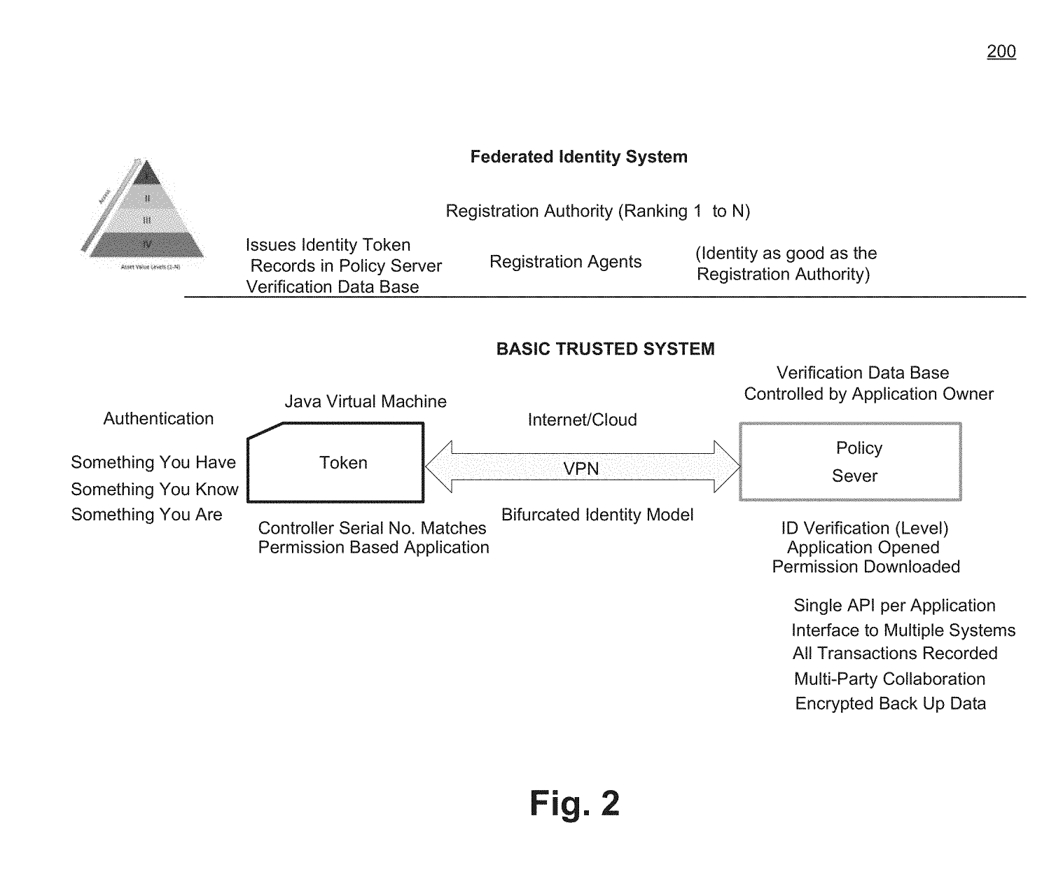

FIG. 2 illustrates the basic components for secure electronic transaction authentication using Trusted System 200, according to an embodiment. Trusted System 200 utilizes a Federated Identity System and a Trusted System Platform. The Federated Identity System provides the means for linking a person's or an organization's electronic identity and attributes that are stored in a policy server to allow access across multiple distinct systems. The Federated Identity System is built on a model that requires participating entities to define a set of policies, practices and protocols to manage the identity and trust levels, e.g., classification levels, shown as an example in FIG. 2 as a pyramid of four levels. In actuality, there are no limits on the number of levels, or ranks, and can be defined by an entity known as a Registration Authority and ranked 1-N. The model requires that the management of users occurs across multiple databases and domains. The Federated Identity System allows for a single sign-on system that permits a single user authentication process across multiple Information Technology systems or organizations at a policy level. A token, in an embodiment the token is a hardware based token, is an integral part of the Federated Identity System as it is related to authentication, permissions and technical interoperability across diverse systems.

The Federated Identity System provides the ability to deal with user and data security where users have different trust levels and the information or systems accessed are within the same network, or at least the same “domain of control.” Users can be prevented from accessing external systems that are fundamentally outside their domain of control. The Federated Identity System in the architecture of Trusted System 200 describes the technologies, standards and use-cases that serve to enable the portability of identity information across otherwise autonomous security domains and thus eliminates the need for completely redundant user administration.

The Trusted System Platform includes authentication utilizing a hardware based token running virtual machine software such as Java Virtual Machine in conjunction with a policy server accessed through the internet or cloud. The Trusted System Platform authenticates users of a hardware based token, to authorize the users to perform certain tasks, secure the data, provide a backend interface to third-party systems as well as to queue transactions when necessary.

The Trusted System Platform authenticates any user that requests access to data that is secured as part of the system. The authentication mechanism is online against a certificate service that is hosted and controlled as part of the system by the trusted policy server. Authentication is at least based on the concepts of “something you have,” something you know,” and “something you are.” Every user is also linked to a public/private key pair certificate that identifies the user and token uniquely, via a manufactured controller serial number, on the policy server, where the manufactured controller serial number exists a priori to a paring or linking of the token to a user. Hashed or encrypted information on the token allows the system to identify whether the user authenticating on the platform is the token owner or not.

Any user that is authenticated is provided with only those rights and roles, i.e., setting of user permissions, which have been granted by the system and by the token owner (if the user is not the token owner). The authentication credentials include unique user identifier, user password and access roles so that the server can identify what type of access is requested and whether the user authenticating is the token owner or another user that is trusted and has the permissions to access the token data platform. The level of access then restricts what actions the user can perform and what data the user has access to at that time.

Encryption is used to protect the data that is stored or transmitted using the token through the Trusted System Platform. In an embodiment, this is achieved via at least three encryption mechanisms. Channel encryption is used where the encryption of the communication channel is via a virtual private network (VPN) or a private block chain network. The data is encrypted and is used to protect data that is stored either on a local or remote server, or directly to a token. Further, key-exchange, e.g., public/private key pairs, is used to provide a mechanism to verify that messages are sent from a valid party.

In an embodiment, the Trusted System Platform uses a contract infrastructure that provides a customized contract legal structure that establishes the following for the specific application of the system:
Identity;
Role;
Rules;
Special Permissions; and
Guarantees.

In an embodiment, the Trusted System Platform uses an update service to maintain the versions of the Trusted System Platform and any applicable application software components. The update service initiates a software component update on a token if any software components on the token are outdated when the token is used. The update service is responsible for:
Storing major and minor release versions of the software components;
Detecting the versions of software components installed on a Token; and
Initiating the necessary software updates to the token.

In an embodiment, the Trusted System Platform uses a policy server to maintain the users and roles for the system, including any trust relationships that have been formed between tokens. The policy server is responsible for:
Authenticating Users/tokens;
Authorizing Users;
Linking and Unlinking tokens (Trust Relationships);
Maintaining all Users and Roles; and
Maintaining a link to the Trusted System Certificate Store.

Further, the policy server controls and ensures assess to data on a token and can include any type of data files, including but not limited to keys, sound files, images, text files, executable files and transaction records without the risk of tampering or invasion of privacy. Access to any of these file is digitally signed.

In an embodiment, the Trusted System Platform uses a policy service to maintain the master repository for the security certificates that are used to identify each token and user of the system. The policy service is responsible for:
Storing all security certificates;
Providing access to create and maintain the security certificates; and
Encrypting and decrypting data using private and public keys stored in a certificate store.

### Architecturally Significant Features

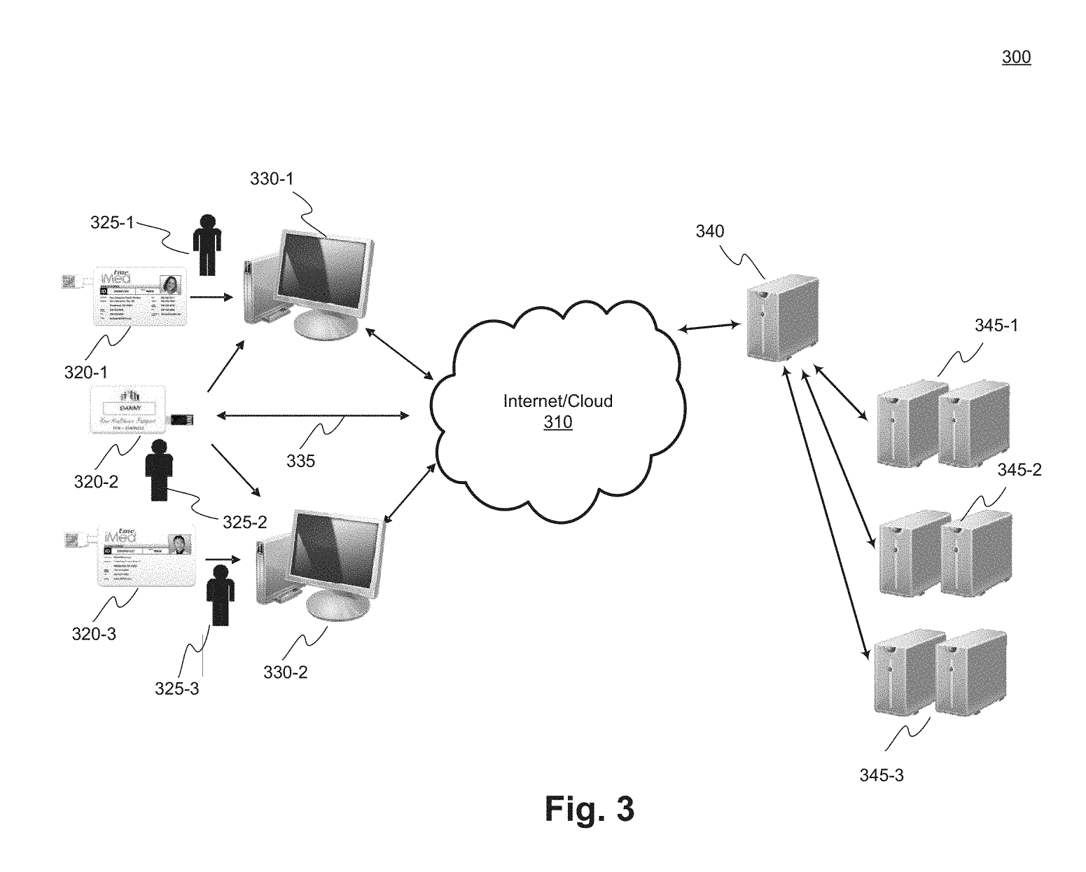

FIG. 3 illustrates a trusted system 300, according to an embodiment. Trusted system 300 includes the Internet/cloud 310, hardware based tokens 320-1, 320-2 and 320-3, users 325-1, 325-2 and 325-3 and policy server 340. Trusted system 300 also illustrates multiple workstations 330-1, 330-2 and 330-3 and other servers such as 345-1, 345-2 and 345-3. Servers 345 can be used as backup servers, database servers, processing servers, policy and authentication server, proxy servers, firewalls, etc.

Users 325 are also referred to as the “card holder, “token holder” or “token owner” that has been allocated a specific token for a particular application or purpose. In FIG. 3, user 325-1 is associated with hardware based token 320-1, user 325-2 with hardware based token 320-2, and user 325-3 with hardware based token 320-3. Each user is associated with a hardware based token that contains specific personal information and is linked to that specific user only. The token is unique to the specific user and cannot contain information that belongs to any other personal token owner. Users 325 can also be referred to as “personal” token owners as the tokens contain their specific personal information for their personal use.

In addition to “personal” token owners, there are two additional classes of token owners. A “provider” token owner owns a specialized token that allows the provider to perform transactions and data updates on a personal token owner's token. Such transactions and updates are typically accomplished by a provider either through a workstation such as workstations 330 or directly through the Internet/cloud 310 to policy server 340 through pathway 335. The connection to the Internet or cloud is typically encrypted.

In additional to the personal token and the provider token, trusted system 300 also defines the use of a system administrator token owner that is any administrative position that has rights to administer trusted system 300 and provides services to personal and provider token owners.

The process of issuing a token to a user, e.g., hardware based token 320-2 to user 325-2, starts with the issuance or “activation” of a hardware based token. Each hardware based token contains a unique identity key. The key is embedded into the token at the time of manufacture of the token. The identity key cannot later be modified or deleted and remains with the token until the token is destroyed. A personal token is activated when it is linked to a personal user or a provider user through a policy server, e.g., policy server 340. The linking is accomplished by tying one or more of a user's biometric information to a specific token where the token must carry a private key and pin, or password, which is linked to the token owner. The biometric information can be any biometric data such as a person's picture, facial image, an iris scan, a fingerprint, facial geometry, etc. Further, the token, in addition to biometric data, can also contain personal details about the user that can be used for the linking process in addition to, or in place of, biometric data. Such linking allows the token owner to digitally sign secure online transactions. Further, biometric identification can be authenticated by a third-party, providing third-party confirmation.

The identity key contained in the token, prior to being activated with a particular user, is stored either in policy server 340, or in a database or backup server 345-1, 345-2 or 345-3. If a specific token identity key is not found in policy server 340 or the database or backup servers 345, then it is considered to be a fraudulent token and will not be activated.

Once a token has been manufactured and activated for a particular user, the user must be authenticated to access data on the token or to process a transaction on trusted system 300. The authentication process will be discussed in more detail below. Once the token is authenticated as being a valid token owner, access to the token and trusted system 300 is restricted to the functionality and data for which the user is authorized. Authentication can only occur when the user has an available communications connection, e.g., the internet, to access trusted system 300. Such authentication occurs during the authentication of a personal token owner and for the authentication of a provider token owner.

After authentication, the personal token owner is able to access data stored on the token is accordance with any authentication rules or restrictions.

In some embodiments, a personal token owner is able to pair the assigned personal user token with a provider token owner's token to create a trust relationship. The trust relationship provides a role-based authorization to any paired provider based on the provider's relationship/role to the personal token owner. Paired tokens will allow the provider token owner to read and write specific data to a personal token owner's token.

Once a user and the user's token are authenticated, a secure online transaction can be processed and can consist of data being written to the token that is signed by all parties participating in the transaction. A secure online transaction must always carry a valid digital signature and all transactions are audited. Further, a secure online transaction can generate additional transactions that may be routed to a third-party service provider.

Trusted system 300 is also able to de-activate a lost or stolen token and detect when a lost or stolen token is used. Further, the owner of a token is able to backup the personal data stored on the token to a backup server such as servers 345 in a secure manner. The backup is encrypted and readable only by a trusted third party. The token owner cannot access this data to view it and can only restore the data to a verified token.

Trusted system 300 can also restore data belonging to a token owner to another specified token. This process is used when trusted system 300 issues a new token to a token owner when a token has been lost or stolen. During this process the token owner is issued a new token and private key for digital signing. The token owner data must also be accessible to the token owner using the newly issued token but no longer accessible using the lost/stolen token.

In addition, a personal token owner or provider is able to export the personal data stored on a token in a standard electronic format. The electronic format may be used to import data into other systems and no longer forms part of trusted system 300, meaning that it is not protected by trusted system 300 in any way.

A personal token owner or provider is also able to import data that is in a standard electronic format into the personal data store of a token. The imported data is verified and authorized by trusted system 300.

### Decisions, Constraints and Justifications

Security of the Trusted System embodiments is a core capability. Authentication within the Trusted System is required for an access request to any data that is secured as part of the Trusted System. The authentication mechanism is online and runs against a certificate service that is hosted and controlled as part of the Trusted System, e.g., policy server 340. Every user is linked to a public/private key pair certificate that identifies the user and token uniquely on the Trusted System. Hashed or encrypted information on the token must allow the Trusted System to identify whether the user authenticating on the platform is the token owner or not.

Regarding authorization, any user that is authenticated is provided with only those rights and roles that have been granted by the Trusted System and by the token owner (if the user is not the token owner). The authentication credentials include a unique user identifier, a user password and an access role so that the server can identify what type of access is requested and whether the user requesting authentication is the token owner or another user that is trusted and has the permissions to access the token data and the Trusted System. The level of access must then restrict what actions the user can perform and to what data the user has authorized access.

The role that a user can assume is determined by a back-end security service, for example running on servers 345. When a user is authenticated, the user credentials must determine whether the user is the token owner or a guest user. A token owner is authorized to perform specific actions that no other user can for his token only. If a guest user (any other user accessing a token that does not belong to them) wants to access information on the token, the guest user's credentials (token) must first be paired with the token owner's token. The pairing of tokens facilitates the granting of access rights by a data owner to a requestor. Both parties must authenticate themselves on the Trusted System to perform the token pairing process and rights are determined based on the pairing configuration in terms of the roles of each of the token holders and the data that the data owner wants to make available. The access to data is controlled by only making data available to a user based on the rights that the user's certificate and role provide. The reliance on a software component on the token to filter the access poses a threat and can be manipulated to expose data or allow actions that the token owner never intended. Leaving the data authorization of a user's access to data to the database engine on the token is also susceptible as the database would be accessible to any authenticated user and be exposed to attacks where an authenticated user may attempt to elevate his rights or gain access to the database data in other ways.

Encryption is used to protect data that is stored or transmitted using a token and the Trusted System. A channel is established first before any communication takes place as the first communication with the Trusted System is typically the credentials of a user requesting authentication. Transport Layer Security (TLS) is used to establish and maintain a secure and encrypted communications channel for the duration of an active user session. OpenSSL, a general purpose cryptography library, can be used to provide the channel with the use of encrypted user information on the token. Messages transmitted over the secure channel also make use of message digests (symmetric algorithms) to prevent tampering with the content of the message. The data on the token is encrypted and is signed using a hash generated by the private keys of the users that must have access to the data. The hashes are stored on the Trusted System to provide a verification mechanism for data stored on the token.

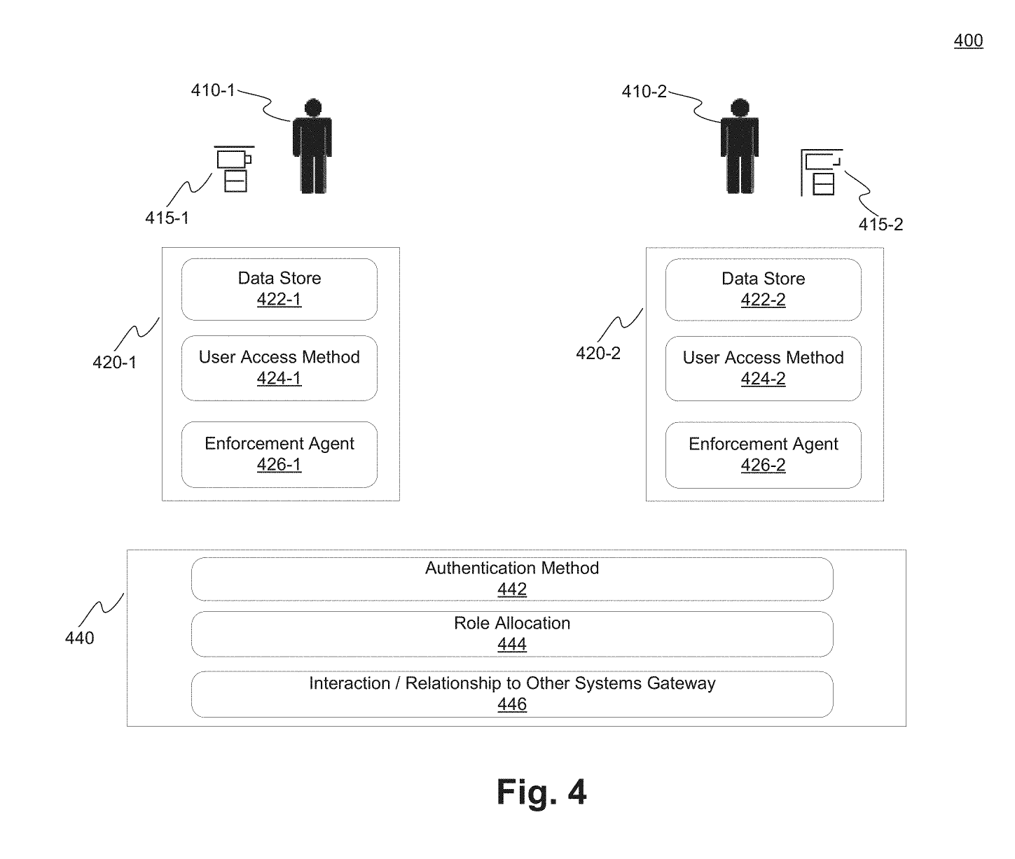

Regarding portability of a verified token, an enforcement agent, user access method and data store in a token, as will be further discussed in FIG. 4, are targeted to function on the Windows, Linux, Macintosh, Android and iOS operating systems. An embodiment of the hardware based token utilizes JavaSE, HTML, XML, JavaDB and pdf within the hardware based token.

The Trusted System is highly scalable and supports multiple concurrent user connections and data integration with third-party services. The Trusted System is based on a Service Oriented Architecture (SOA) to provide high scalability and flexibility by hosting back-end services for application processing and intermediate aggregation where necessary. The services support Simple Object Access Protocol (SOAP) over HTTP and implement a standard message envelope to cater for message security and integrity on the Trusted System platform. The standard message format is XML-based and messages may be stored for long-running transactions or third-party integration requirements, including batching and conversion where necessary. The implementation of BizTalk as a message routing engine can be used to provide transaction management, fault recovery and standard message format implementations.

The Trusted System provides an integration mechanism to third-party service providers or in-house services that are available to tokens. Integration is implemented using an integration service that can manage message storage, queuing, routing, transformation, rules and multi-channel and multi-format message and data integration.

FIG. 4 illustrates a physical and a logical view of a hardware based token system 400, according to an embodiment. Hardware based token system 400 includes users 410-1 and 410-2, token 415-1 and 415-2 (both tokens being hardware based) that are logically represented as 420-1 and 420-2. Hardware based token system 400 also includes a trusted exchange server 440. User 410-1 is the person who has been allocated token 415-1. User 410-2 is the person who has been allocated token 415-2.

Each token includes a data store, 422-1 or 422-2, a user access method, 424-1 or 424-2, and an enforcement agent 426-1 or 426-2. Trusted exchange server 440 includes an authentication method 442, a role allocation 444, and an interaction/Relationship to Other Systems Gateway 446.

User 410-2 can be a standalone user using token 415-2 for its own transactions. However, in some scenarios, a second role-player may have rights associated with them to participate or fulfill types of transactions. However, such a multiple user transaction would be governed by authentication method 442.

Data stores 422-1 and 422-2 are on-board memory in token 415-1 and 415-2, respectively. Data stores 422-1 and 422-2 are able to store anything that can be converted to a format that can be stored on a memory device. Users 410 can, by communicatively coupling hardware based token 415 into any electronic device, e.g., workstation 330 or policy server 340, where that device can execute user access method 424, can then access data stored in data store 422, given that the roles and rules for user 410 and token 415 grant such access from trusted exchange server 440, i.e., a policy server. The level of access and the role for user 410 is governed by enforcement agent 426. In FIG. 4, that means that enforcement agent 426-1 governs the level and role of access for user 410-1 to token 415-1.

The access and presentation of data within data store 422, as well as the ability to initiate any other transaction is controlled through user access method 424. The functionality provided by user access method 424 can be provided via any method or approach using current or future coding methods.

Enforcement agent 426, depending on how the system is to be used, makes use of any methodology, cryptology, and security system to authenticate a user or application. Based on the level or authentication required to access any component of the solution, enforcement agent 426 will control and limit access to data store 422 and enable features and function in user access method 424. Enforcement agent 426 is used to pass user credentials to authentication method 442 in trusted exchange server 440. Trusted exchange server 440 is used to authenticate the user and assign the associated roles to the user as controlled by role allocation 444 and then passed back to enforcement agent 426 and then used by user access method 424 to access data store 422.

Therefore, trusted exchange server 440 is used to:
authenticate all users and applications;
host and enforce the user and token roles;
provide the ability to queue messages when necessary;
provide the means to integrate to third-party or other systems; and
provide an audit capability.

In an embodiment, two or more tokens can be paired to activate specific types of transactions. Paired token transactions can include, but not limited to, the pairing of token 415-1 and token 415-2 together with roles allocated by role allocation 444 of trusted exchange server 440 and enforcement agent 426-1 where token 415-1 is issued specific rights to user 410-2 for either token 415-1 or token 415-2.

In another embodiment, tokens 415-1 and 415-2 are paired where they are governed by role allocation 444 of trusted exchange server 440 that results in a transaction to an external system (not shown) under the rules and control of the interaction/relationship to other systems gateway 446 as a gateway service, or initiate any other service within the trusted exchange environment.

In another embodiment, tokens 415-1 and 415-2 are paired where they are governed by role allocation 444 of trusted exchange server 440 that allows either token 415-1 or token 415-2 to effect one, some or all of functions of either token 415-1 or 415-2, such as open, save, update, edit, create, delete, rename, move, add, append, concatenate, comment, compile and/or browse functions.

In embodiments with multiple tokens, one, two or more tokens can form part of a solution. The second, third or multiple tokens may or may not have stored information on them, and depending on the application of the solution it may or may not be accessed by a particular user, for example, user 410-2 after the relevant authorization by enforcement agent 426-2 and using the appropriate method defined in user access method 424-2.

In an embodiment using multiple tokens, for example, enforcement agent 426-2 that secures all aspects of token 415-2 can be used to manage the roles of other tokens. In such a scenario, after identifying user 410-2 and allowing access to token 415-2 locally, authentication method 442 of trusted exchange server 440 is called, which identifies user 410-2's role in role allocation 444. After the authentication process has been executed, and user 410-2's role has been defined, user 410-2 and token 415-2 can access data on token 415-2, or have access to some, or all data on token 415-1 stored in data store 422-1. In such a scenario, enforcement agent 426-2 transfer credentials to authentication method 442 and role allocation 444 and back down to enforcement agent 426-1.

Authentication method 442 on trusted exchange server 440 interacts with the total solution in different ways and at different times. When user 410-1 inputs or couples token 415-1 into any system, enforcement agent 426-1 applies access rights to these users' credentials. Enforcement agent 426-1 may, under certain conditions, initiate a request to authentication method 442 to obtain additional rights to engage user access method 424-4 and/or data store 422-1. Authentication method 442 may also, under certain conditions, accept a request from token 415-2. These requests could take place concurrently or singularly, and under specific conditions, the rights issued to user 410-2 and token 415-2 could depend on the identity of user 410-1 and token 415-1.

Role allocation 444, shown as part of trusted exchange server 440, could be part of any other server. In fact, the roles of authentication method 442, role allocation 444, and interaction/relationship to other systems gateway 446 can operate on the same or separate computational systems. The illustration in FIG. 4 is by way of example and not meant to be limiting.

Role allocation 444 manages the roles executed by any component of the solution. Once user 410-1 and token 415-1 have been identified and authenticated, and enforcement agent 426-1 has activated, a request may be issued to authentication method 442 to authenticate user 410-1 and token 415-1 into trusted exchange server 440. Once this has taken place, the credentials are passed to role allocation 444 that issues the relevant role to user 410-1 and token 415-1, which could include some or all of a set of functions, e.g., open, save, update, edit, create, delete, rename, move, add, append, concatenate, comment, compile and/or browse functions of anything on token 415-1. There are instances where user 410-1 with token 415-1 and user 410-2 with token 415-2 are executing a joint or mutual transaction that require different roles being issued by role allocation 444 to token 415-1 and token 415-2. There are instances where with the appropriate authentication and role allocation being issued to token 415-2 and user 410-2 includes access to data on token 415-1. Depending on the authentication and role allocation process, user 410-2 with token 415-2 may be issued some or all of a set of functions such as e.g., open, save, update, edit, create, delete, rename, move, add, append, concatenate, comment, compile and/or browse functions of anything on token 415-1.

Interaction/relationship to other systems gateway 446 allows the trusted solution to send transactions to and receive transactions from systems external to the trusted system in a secure and managed method. User 410-1 and token 415-1, independently, or in combination with user 410-2 with token 415-2, can initiate certain transactions, in this scenario a call is generated by Interaction/relationship to other systems gateway 446 to an external system. The transaction is typically initiated by user 410-1 and token 415-1 and authenticated by enforcement agent 426-1 and then authenticated into trusted exchange server 440 by authentication method 442 and an appropriate role being issued by role allocation 444. Concurrently, or independently, user 410-2 with token 415-2 is authenticated by enforcement agent 426-2. User 410-2 is then authenticated into trusted exchange server 440 by authentication method 442 and an appropriate role is issued by role allocation 444. The matching of the two appropriately authenticated tokens and users allow for a unique set of transactions that could include any type of transaction to an external system.

### Security Architecture

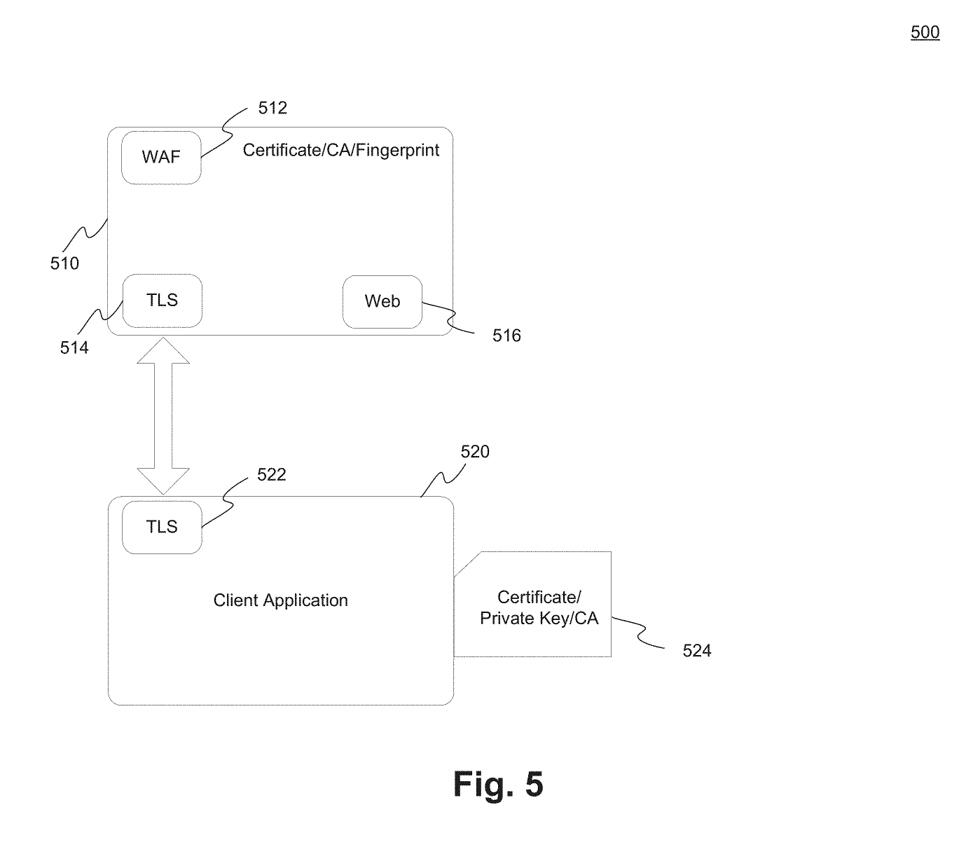

FIG. 5 illustrates communication channel security system 500 in a trusted system, according to an embodiment. Communication channel security system 500 utilizes security in the establishment of a secure communications channel between a token and the Trusted System. Communication channel security system 500 includes a web server 510 and a token 520 (hardware based). Web server 510 includes a Web application firewall (WAF) 512, a transport layer security (TLS) 514 and an internet web interface 516. Token 520 includes a transport layer security (TLS) 522 and a token chip 524. Web server 510 performs the functions of a policy server as discussed in FIGS. 2-4.

Web server 510 has installed WAF 512, also known as a “Deep Packet Inspection Firewalls.” WAF 512 inspects every request and response within the HTTP/HTTPS/SOAP/XML-RPC/Web Service layers. In general Web Application Firewalls look for certain “attack signatures” in an attempt to identify a specific attack that an intruder may be sending, while others look for abnormal behavior that are not consistent with a website's normal traffic pattern. Web Application Firewalls can be either software or hardware based, and are installed in front of a web server in an effort to try and shield it from incoming attacks.

In an embodiment, token 520 uses a USB port to communicate with a server or workstation. When token 520 is coupled into the USB device of a computer the client application is started. The token then attempts to access web server 510 using OPENSSL, configured for using TLS 1.2, via the internet or private network. Web server 510 recognizes the request and sends its public certificate to the client application. In response, the client application verifies the received public certificate against the Certificate Authority (CA) stored in token 520. If the public certificate matches the CA, then web server 510 is considered to be a trusted entity.

Once web server 510's public key is certified, a client application running on token 520 sends token 520's public certificate to web server 510 where web server 510 authorizes token 520's public certificate against the certificate authority on the server to establish if token 520 is a trusted token.

If both keys are certified, a trusted and secure channel is established between the client application on token 520 and web server 510. Encryption technology is configured, in an embodiment, in OPENSSL and SHA512 that are used as a hashing algorithm and further where RSA1024 bit technology is used for encryption.

Token 520 includes a processor that is used to secure the transactions and ensure that full data integrity in maintained. Token 520 also contains the following data:
token owner's private key;
token owner's public key;
token owner unique certificate identifier;
a public key;
token owner biometric data, e.g., picture/photo, fingerprint, iris scan, etc.;
unique user identifier;
unique token identifier; and
Personal Identification Number (PIN) to access token.

In an embodiment, token 520 is programmed to write the token owner's private and public keys once. Token 520 will also read any public key and does not allow read access to the token owner's private key. When token 520 receives an encrypted key that requires the token owner's private key to be decrypted, it is processed by token chip 524 in token 520. In doing so, this means that the token owner's private key is never divulged and never allowed to be read from token chip 524.

Once a trusted channel has been established then the process of authentication is initiated. In an embodiment, a session identifier and sequence number are used to do the authentication. The steps for authentication include the following:
Web server 510 encrypts the session identifier and sequence number with the user's public key stored in a key store;
the result of the above encryption is then encrypted with the web server 510's trusted system private key and is sent to the client application;
the client application within token 520 decrypts the authentication transaction with the public key; and
the session identifier and sequence number are then decrypted with the token user's private key.

The session identifier and sequence number are used in each transaction sent from token 520 to web server 510 and vice versa. The sequence number is a number generated by web server 510 to track all sessions and to check for any duplicates. The Trusted System, e.g., web server 510, maintains a database of all paired “linked” tokens and the rights that token owners have granted. The configuration can be maintained by a token owner at any time after authenticating and authorizing against the Trusted System.

A secure transaction is any transaction or record update that affects a token owner's data store and can also initiate a transaction to third-party service providers. Once the secure channel is established and the authentication has completed, all transactions sent between token 520 and web server 510 have the components that are described below.

Magic Number: In an embodiment, the magic number is a 32 bit number assigned by the web server 510 or by the controller number on token chip 524, to use with all transactions. The number is the same for all transactions and is used by the system to identify if the transaction packet is a Trusted System transaction. This is an early checkpoint to check if the transaction is a valid Trusted System transaction. If the magic number is not a number recognized by policy server 340 the transaction is ignored.

Hash Algorithm Type: The hash algorithm type is an identifier of which algorithm type was used when hashing the file. This gives the Trusted System the ability to change the hash algorithm over time and still have the ability to compare hash codes using the specified algorithm type.

SessionID: The SessionID (session identifier) is the identifier of the established secure session between token 520 and web server 510. If transactions are received with different SessionID's than the current established session, the transaction is identified as an unsafe transaction and ignored.

Transaction Code: All transactions have a transaction code. This code is used to group transactions together and is separate and distinct from a transaction identifier or sequence number.

Transaction Instruction: Different transaction types used by the Trusted System have a unique instruction type identifier. This identifier code is used by the system to know what type of transaction it is expecting and how to handle it.

Transaction Sequence Number: Each transaction has a sequence number. Sequence numbers are incremented per transaction and per transaction code. This ensures that all transaction packets for a specific code are received and received in sequence. The application identifies gaps and or duplicate transactions early in the process by validating the sequence number.

Instruction Issuer: Each transaction is signed by the issuer and the system needs to know who the signatory is. The system can then get the signatory's public key from the key store and use this key to decrypt the signed hash code.

Length of Content: Length of content is the expected number of bytes of the expected content. This is protecting the system from buffer overruns when receiving transactions. If the length of the received content is more than the specified length, the transaction is identified as unsafe and ignored.

Content: The content packet is the metadata that is sent between token 520 and web server 510 and contains the actual data of the transaction.

Issuer Signed Hash: Transaction segments are hashed using SHA512 or MD6. Hashing is the ability to mathematically reduce a variable length of data into a reproducible fixed length “digest” of that message. The hash string is then encrypted using the issuer's private key and is added to the transaction packet. This encryption acts as the signature of the transaction and cannot be decrypted by anyone other than the issuer.

Server Signed Hash: An additional hash string is signed by the issuer using web server 510's public key. This hash string is then decrypted by web server 510, using web server 510's private key, and the validity of the transaction content is checked using this hash.

The data storage architecture consists of multiple virtual containers of data that are related to a trusted relationship between token owner and any other user in which the token owner interacts. Each trusted user is to have a virtual container that holds transactions and data updates, e.g., documents, which are generated by that trusted user. Container records can only be appended, never edited or deleted so that each record is treated as immutable and unalterable, thus providing verifiable, trusted and reputable proof of a transaction.

Data on token 520 is stored encrypted using a symmetric key generated by both a web server 510 key generator and a token 520 client key generator. Additional data are stored with the encrypted metadata in order to identify the different records.

Each data record is stored in a data records database on web server 510, or any other server, and can optionally be encrypted based on the transaction type. Further, each data record has an index record that links to the record using a unique transaction ID. The records in an index database may contain meta-data for the data record to facilitate filtering or searching and for each record in the index. There is at least one corresponding record in the key store database. All records are linked using the unique transaction id. The record in the key store contains the encryption type, proxy certificate, unique certificate identifier, and the encrypted symmetric key that was used to encrypt the transaction in the data table. The encryption type identifies the decryption algorithm to use when decrypting the symmetric key. The proxy certificate thumbprint is the public key thumbprint of the entity that can decrypt the symmetric key. The symmetric key is encrypted using the proxy's public key and stored in the key store. Only an entity with that specific public/private key can decrypt the symmetric key, which in turn is used for decrypting the transaction.

If the token owner wants to give an entity, (proxy) access to a specific record the system uses the token owner's public key to decrypt the saved symmetric key. This symmetric key is then encrypted using the proxy's public key. A new record is added to the key store with the transaction identifier and the relevant details of the proxy as well as the newly encrypted symmetric key. When the proxy reads the data he can use his own private key to decrypt the transaction and thus can read the transaction.

This above approach provides the basis for digitally signing each document and ensures nonrepudiation of the document transaction. Additional standards such as XAdES (XML Advance Electronic Signatures) for data storage can be applied but are not necessary to achieve digital signing.

### Architectural Variations

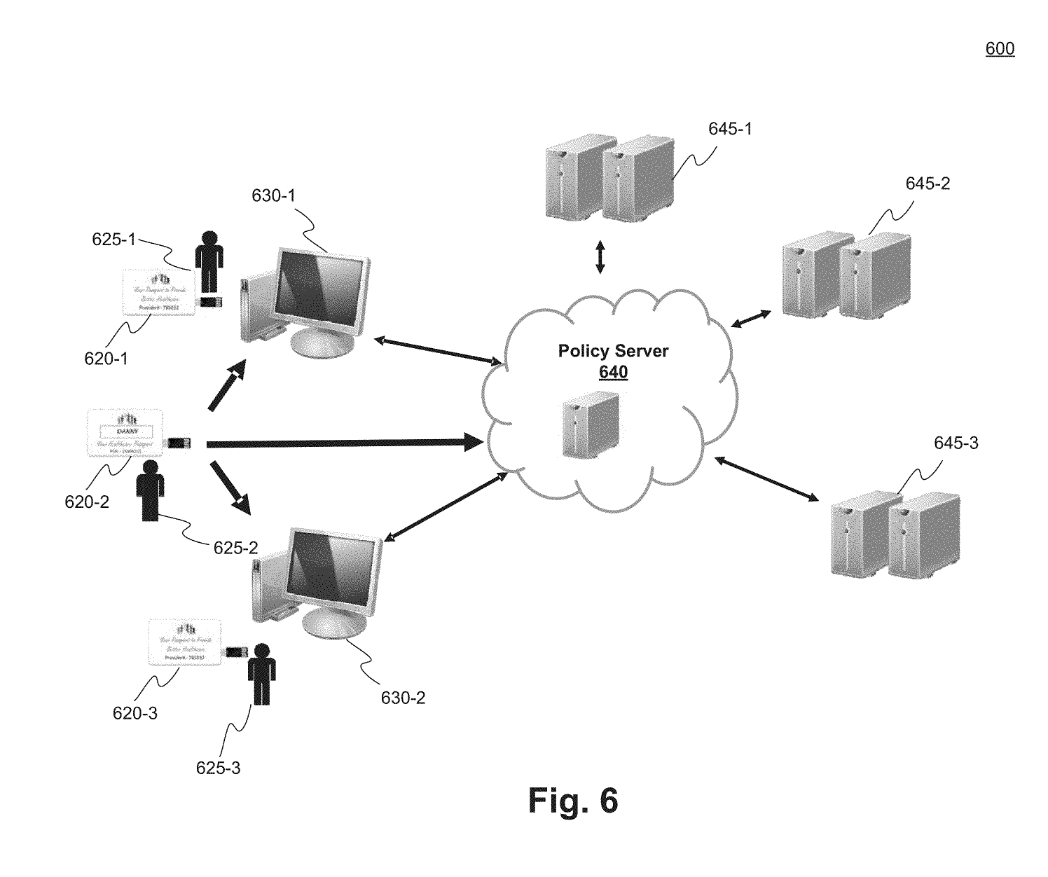

FIG. 6 illustrates a trusted system 600, according to an embodiment. Trusted system 600 includes a policy server 640, tokens 620-1, 620-2 and 620-3 (hardware based), users 625-1, 625-2 and 625-3. Trusted system 600 also illustrates multiple workstations 630-1 and 630-2, and other servers such as 645-1, 645-2 and 645-3.

Trusted system 600 is similar to trusted system 300 described in FIG. 3. However, trusted system 600 does not include an internet or cloud connection. User 625-1 is associated with token 620-1, user 625-2 with token 620-2, and user 625-3 with token 620-3. When user 625 desires to initiate a transaction, or transaction request, user 625 has the option of coupling to policy server 640 directly. Such coupling can be wired or wireless using any communication methodology including Wi-Fi, cellular, Bluetooth, infrared, or any other communication technology.

In some embodiments, user 625 may be required to initiate a transaction through a personal computer or workstation, such as workstation 630. As will be discussed later, such a situation can occur in a medical system implementation where user 625-1 may represent a physician, user 625-2 represents a patient, and user 625-3 represents a hospital, emergency room or pharmacy technician. In such a situation a patient, user 625-2, may be instructed to insert his/her token 620-2 into the physician's workstation 630-1 to be authenticated. In such an embodiment, servers 645 could contain patient healthcare records, health plan databases and other processing servers.

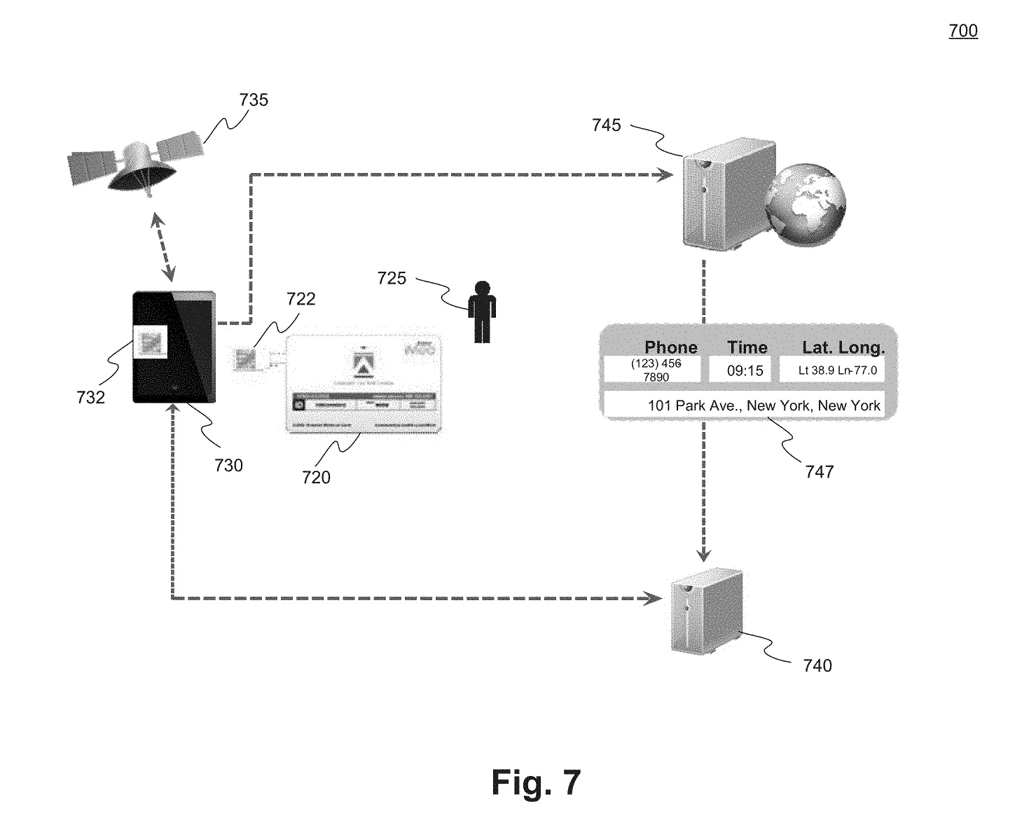

FIG. 7 illustrates a trusted system platform 700 using a global positioning system for ongoing authentication, according to an embodiment. Trusted system platform 700 includes a hardware based token 720 with a token chip 722, user 725, a portable electronic device 730 with a device chip 732, a global positioning satellite 735, a trusted system server 740, a global positioning system (GPS) location database server 745 and GPS location identifier 747.

Trusted system platform 700 adds an additional authentication factor and can be applied to those systems and embodiments previously discussed. Therefore, where as previously discussed, a hardware based token contains biometric identification data of the user and the policy server is used to provide authentication of the user based on a number of factors, where those factors include possession of the hardware based token by the user, a matching of the manufactured identity key with a priori registered key stored on the policy server, the public/private key pair, a user password, and the biometric identification data. Thus, in addition to these authentication factors, a GPS location is also required.

For example, user 725 is dispatched to perform a certain service at a particular location, e.g., 101 Park Ave, New York, N.Y. In this scenario, user 725, who is associated with hardware based token 720, is told to travel to the designated location. Once arrived, user 725 would insert hardware based token 720 into portable electronic device 730 for authentication. Portable electronic device 730 is equipped with a GPS receiver and in addition to the above discussed authentication factors, portable electronic device 730 would communicate the all of the authentication factors, including the GPS coordinates of user 725 back to trusted system server 740. The GPS coordinates would also be received by GPS location database server 745. GPS location database server 745 would translate the received GPS coordinates into GPS location identifier 747. The GPS location identifier 747 shown in FIG. 7 indicates a phone number, time, latitude and longitude, and address are meant to be illustrative, not limiting and can included less or more information as is deemed necessary by an application. Trusted system server 740 would then compare the location of user 725 to the dispatched GPS location. If the comparison renders a match, user 725 could then be authenticated.

In an embodiment, portable electronic device 730 can be any type of electronic device with GPS capabilities such as a smartphone, laptop computer, tablet, smart-watch, etc.

In an embodiment, the actual location of user 725 is persistent and would continue to be analyzed. For example, a threshold could be set that at every X minutes, or if portable electronic device 730 detects movement, portable electronic device 730, equipped with a GPS receiver, would send an updated set of GPS coordinates to trusted system server 740 and GPS location database server 745. If, at any point, the GPS coordinates of user 725 varies from the dispatched GPS coordinates by greater than a threshold amount, e.g., the actual user GPS position does not match the expected GPS position, user 725's authentication would be terminated and user 725 could no longer access trusted system server 740 or any restricted data or applications on hardware based token 720 or portable electronic device 730. A series of GPS coordinates, or GPS locations, being transmitted and received allows for an ongoing monitoring of a user's location.

Further, as previously described, authentication also requires verification of a unique identity key contained on token chip 722. In an embodiment, authentication also requires verification of a unique identity key contained on device chip 732 in portable electronic device 730. Such verification requires the use of only portable electronic device 730, versus a different portable electronic device, and thwarts user 725, or anyone else, from substituting devices and the information contained therein.

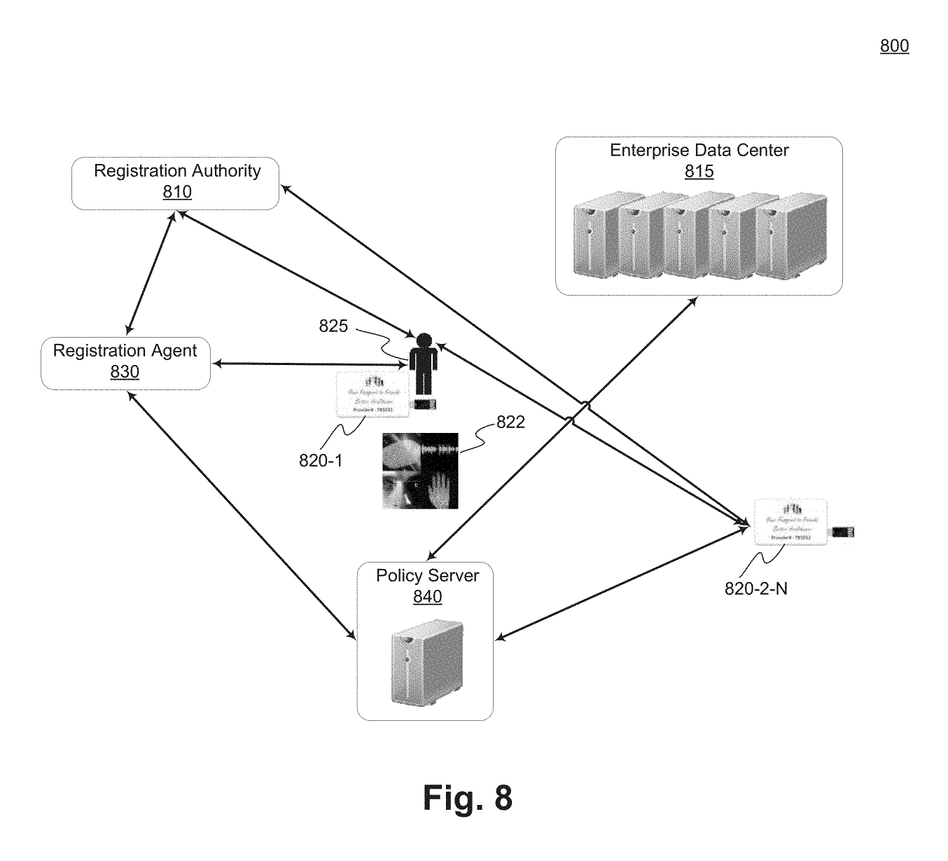

FIG. 8 illustrates a trusted system 800 that includes a registration authority, according to an embodiment. Trusted system 800 includes a registration authority 810, an enterprise data center 815, a user 825, a hardware based token 820-1 with a token chip, a repository of hardware based tokens 820-2-N, biometric data 822 and a registration agent 830.

Trusted system 800 utilizes a federated identity structure rather than creating a multilevel secure database. Permission based user identification, through the Federated Identity System, consists of a registration authority, a registration agent, level of verification, clearance access, organization, current role, biometric data, and a unique token identifier.

Registration authority 810 is used to vet and establish clearance levels and permissions for each individual within its organization. There can be one or more registration authorities, each authority responsible for its users. Registration agent 830 is used to verify identity and register an individual user to the system, according to registration authority 810 and issues and verifies hardware based tokens, for example obtaining new unverified hardware based tokens from the repository of unverified hardware based tokens 820-2-N. Once a hardware based token 820-2-N is “paired” with a particular user, identity is bound to the token and credential registration is issued to policy server 840. Once registered the individual enrollment is complete. Further, individuals can be classes of user, such as first responders, police, etc.

Policy server 840 also contains the roles and rules for each user, for example, the extent of access assigned to a user for enterprise data center 815, e.g., one user can only access the first level of enterprise data center 815 while another has access to all five levels. Further, trusted system 800 also contains a database of biometric data 822 that can be used in the authentication process.

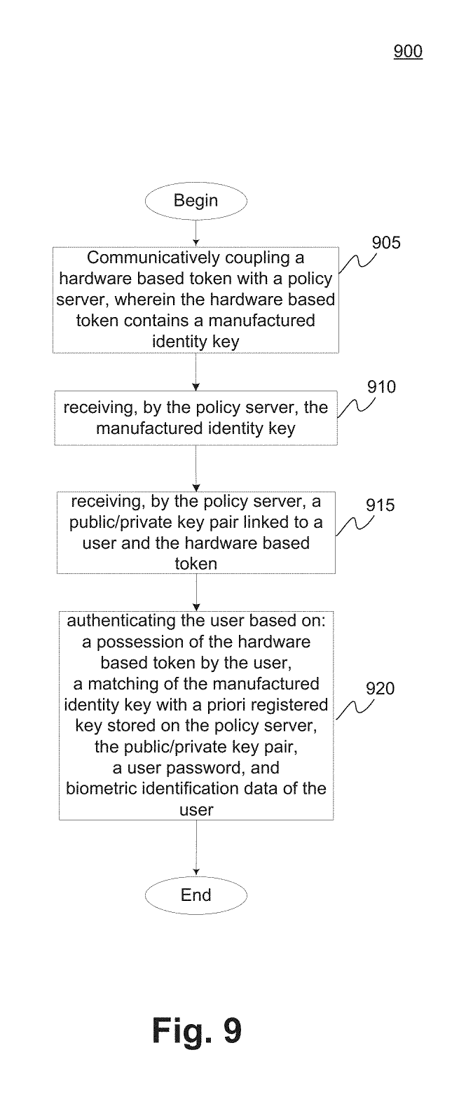

FIG. 9 shows an exemplary embodiment of a method 900 for conducting secure electronic transactions, according to an embodiment. Method 900 begins at step 905 with the communicative coupling of a hardware based token with a policy server, wherein the hardware based token contains a manufactured identity key. For example, FIG. 3 illustrates the process of issuing a token to a user, e.g., hardware based token 320-2 to user 325-2, and starts with the issuance or “activation” of a hardware based token. Each hardware based token contains a unique identity key. The key is embedded into the token at the time of manufacture of the token. The identity key cannot later be modified or deleted and remains with the token until the token is destroyed. A personal token is activated when it is linked to a personal user or a provider user through a policy server, e.g., policy server 340. In addition, FIG. 4 illustrates the functionality of a hardware based token where users 410 can, by communicatively coupling token 415 into any electronic device, e.g., workstation 330 or policy server 340, where that device can execute user access method 424, can then access data stored in data store 422, given that the roles and rules for user 410 and token 415 grant such access from trusted exchange server 440, i.e., a policy server.

Method 900 continues to step 910 where the policy server receives the manufactured identity key. For example, as discussed in FIG. 5, web server 510 is a policy server. FIG. 5 illustrates the process of authentication where when token 520 is coupled into the USB device of a computer the client application is started. The token then attempts to access web server 510 using OPENSSL, configured for using TLS 1.2, via the internet or private network. Web server 510 recognizes the request and sends its public certificate to the client application. In response, the client application verifies the received public certificate against the Certificate Authority (CA) stored in token 520. If the public certificate matches the CA, then web server 510 is considered to be a trusted entity. Once web server 510's public key is certified, a client application running on token 520 sends token 520's public certificate to web server 510 where web server 510 authorizes token 520's public certificate against the certificate authority on the server to establish if token 520 is a trusted token.

Method 900 continues to step 915 where the policy server receives a public/private key pair linked to a user and the hardware based token. As previously discussed, authentication is at least based on the concepts of “something you have,” something you know,” and “something you are.” Every user is also linked to a public/private key pair certificate that identifies the user and token uniquely, via a manufactured controller serial number, on the policy server. Hashed or encrypted information on the token allows the system to identify whether the user authenticating on the platform is the token owner or not. Further, as discussed in FIG. 5, the symmetric key is encrypted using the proxy's public key and stored in the key store. Only an entity with that specific public/private key can decrypt the symmetric key, which in turn is used for decrypting the transaction.

Method 900 continues to step 920 where authenticating the user is based on multiple factors, including: (1) a possession of the hardware based token by the user; (2) a matching of the manufactured identity key with a priori registered key stored on the policy server; (3) the public/private key pair; (4) a user password, and; (5) biometric identification data of the user. For example, as discussed in FIG. 7, authentication includes a hardware based token contains biometric identification data of the user and the policy server is used to provide authentication of the user based on a number of factors, where those factors include possession of the hardware based token by the user, a matching of the manufactured identity key with a priori registered key stored on the policy server, the public/private key pair, a user password, and the biometric identification data. Method 900 then ends.

### Secure Electronic Transaction Alternate Embodiments

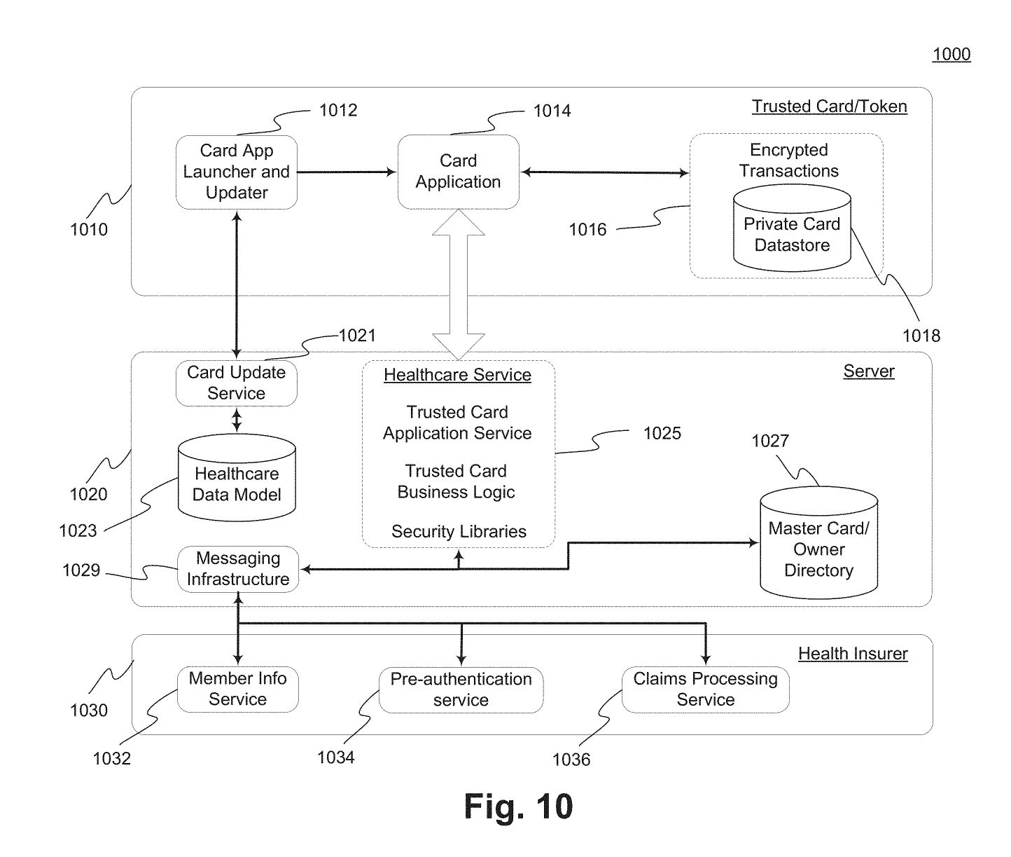

FIG. 10 illustrates a trusted system 1000 architectural solution in healthcare, according to an embodiment. Trusted system 1000 includes a hardware based token that is referred to as trusted card 1010. Trusted system 1000 also includes a server 1020 for processing healthcare data and a health insurer 1030. Trusted system 1000 requires a communications link between trusted card 1010 and server 1020. While the communications link typically is the internet, the system can also be accomplished using private or corporate networked communications.

As discussed in FIGS. 2-9, the token, or in FIG. 10, trusted card 1010 requires a token chip in trusted card 1010 that contains a manufactured identity key, a private key and other possible private credentials for offline use of trusted card 1010.

Trusted card 1010 includes a card application launcher and updater 1012, a card application 1014, and a private card data store 1018 which includes encrypted transactions 1016. In terms of card application functionality, trusted card 1010 is responsible for a user login, running an industry application user interface, and reading and writing to and from private card data store 1018. If a valid trusted card chip is present trusted card 1010 can encrypt and decrypt data.

Server 1020 includes a card update service 1021, a healthcare data model 1023, and a healthcare services module 1025 that is responsible for trusted card application services, trusted card business logic and security libraries. Server 1020 also includes a master card/owner directory 1027 and a messaging infrastructure 1029. Card update service 1021 keeps card application launcher and updater 1012 and card application 1014 updated. Messaging infrastructure 1029 controls messaging and guarantees delivery for transactions and provides for third-party provider integration. Server 1020 also includes healthcare services module 1025 that controls business logic for card applications and implements a user interface. Server 1020 also controls the security libraries to authenticate and authorize trusted card 1010.

Health insurer 1030 includes member information service 1032, pre-authentication service 1034 and claims processing service 1036.

The sequence of steps to initiate a transaction includes the user launching card application launcher and update 1012 and then logging into the system This establishes a connection with server 1020. Server 1020, using master card/owner directory 1027 authenticates and authorizes the user. This authentication and authorization is communicated back to trusted card 1010 and the card industry application is launched. The user can then continue and interact with the application on card application 1014.

The application architecture of trusted system 1000 includes multiple sub-systems and applications. These sub-systems include a launcher, a trusted system update service, a trusted system security service, a trusted system integration service, an industry application for medical systems and industry application services.

The launcher provides the initial capability to launch the trusted system update service and any industry application on trusted card 1010. The launcher is responsible for identifying the platform that trusted card 1010 is running on and is also responsible for calling the appropriate versions of applications for a given platform. Further the launcher calls the trusted system update service to download application updates.

The trusted system update service maintains the versions of the trusted system and application software components. The update service initiates a software component update on trusted card 1010 if any software components on trusted card 1010 are outdated when trusted card 1010 is used. The update service is responsible for storing major and minor release versions of the software components and also detects the versions of the software components installed on trusted card 1010. The update service also initiates the necessary software updates to trusted card 1010.

The trusted system security service maintains the users and roles for the system, including any trust relationships that have been formed between Trusted Card/Tokens. The service is implemented as a library which exposes the services via a defined interface that is extended for each Industry Application. The service utilizes two additional internal libraries called the Certificate Service and Transaction Service. It is directly responsible for authenticating users and trusted cards/tokens, authorizing users, linking and unlinking trusted cards/tokens to users, e.g., trust relationships, maintaining all users and roles, and maintaining a link to the certificate store.

The trusted system security service also includes a certificate service library that maintains the master repository for the security certificates that are used to identify each trusted card/token and user of the security service. The library is responsible for storing all security certificates, providing access to create and maintain the security certificates, encrypt and decrypt data using private and public keys stored in the certificate store.

The trusted system security service also includes a transaction services library that validates and signs all transactions and data updates to trusted cards/token. The service is responsible for determining transaction validity, determining transaction authorization, signing transactions, storing transactions or routing transactions for processing by other external or internal interfaces.

The trusted system integration service is an infrastructure service. Such a service can be provided by a BizTalk Server that provides a platform for integration with third-party service providers. It is responsible for maintaining a service registry, maintaining service on and off ramps, message transformation, message routing and the implementation of service itineraries, and message persistence.

The industry application is an industry implementation that runs on trusted system 1000. The application executes a user interface on trusted card 1010 that can perform specific transactions and is overlaid with server 1020 functionality. It also interacts with an industry application services that are hosted by trusted system 1000.

The industry application services include specific services that service an industry application running on a trusted card/token. The services provide specific industry-based functionality and conform to server 1020 platform requirements in terms of security, transactions and data storage. In this case, the implementation of the server 1020 interface is through a Healthcare Service that contains the application and processing login for the Healthcare industry data model.

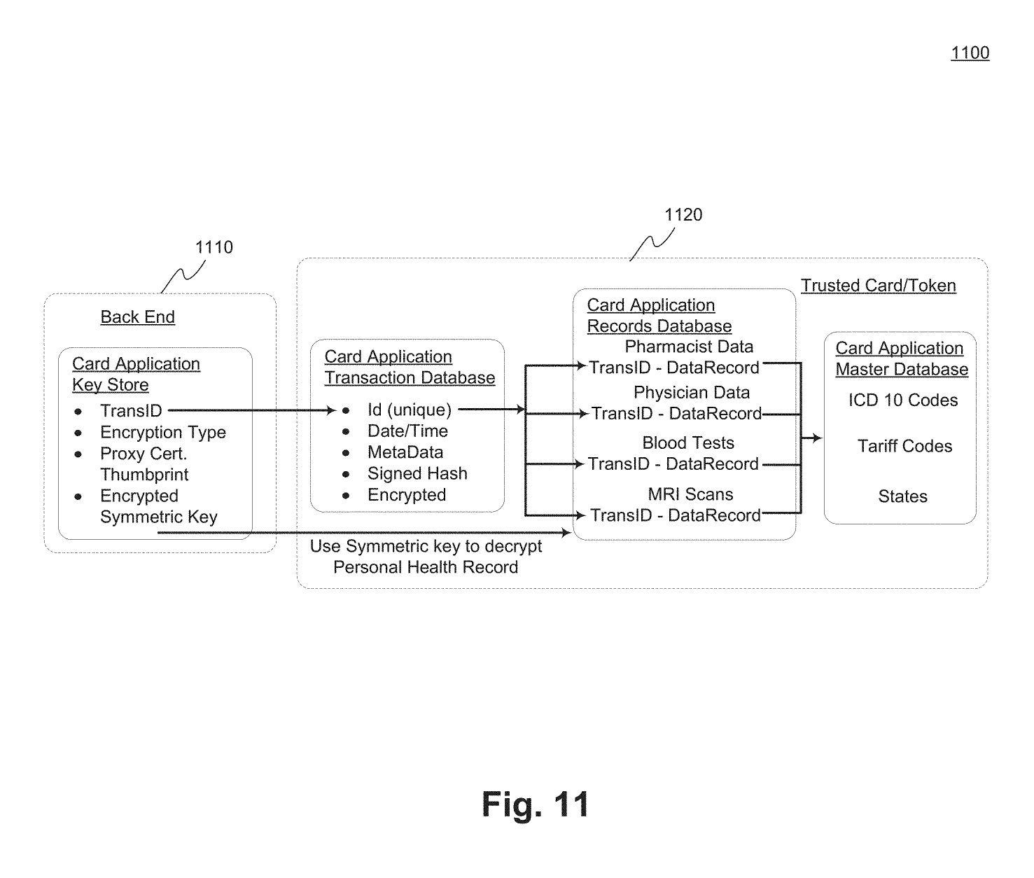

FIG. 11 illustrates logical relationships 1100 between various logical data sources contained on a trusted card/token, according to an embodiment. FIG. 11 is directed to data used in healthcare industry such as a Personal Health Record (PHR).

The following listing is provided to define possible data sources, description and where the data sources can be found. The listing consist of the “data source,” “description” and “location.”

| Data Source | Description | Location |
|---|---|---|
| Card/Token Application | Data records and media stored | Card/Token |
| Records Database | specifically by the Industry | |
| (Structured/Unstructured) | Application, such as personal data, | |
| | images, videos | |
| Card/Token Application | Metadata for all encrypted data and | Card/Token |
| Transaction Database | a pointer to the data record or data | |
| | item (if unstructured) | |
| Card/Token Application | Stores encrypted symmetric keys | Server |
| Key Store | that act as pointers to the | |
| | Card/Token Application | |
| | Transaction Database | |
| Card/Token Application | Master Data that is used by the | Card/Token and |
| Master Database | Industry Application on the | Server |
| | Trusted Card Token (e.g., | |
| | ICD10/Tariff, etc.) | |
| Integration Transaction | Transactions that are generated by | Server |
| Database | the Trusted System and routed to | |
| | third-party providers for | |
| | processing | |
| Transaction Metadata | Records all metadata for | Server |
| Database | transactions that are processed | |
| | through the Trusted System Server | |
| Master Database | Master Data database stored in | Server |
| | server and drives business rules, | |
| | integration and acts as a source for | |
| | synchronizing the Card/Token | |
| | Application Master Database | |
| Audit Database | An audit database that records all | Server |
| | auditable data items and stores | |
| | them for further investigation. | |
| Synchronization | Versions/Release Packages. May | Server |
| Database | also retain interim data for master | |
| | data synchronization. | |
| Certificate Database | Database for private and public | Server |
| | key certificate pairs | |
| Security Database | Stores all users, groups, roles and | Server |
| | privileges. It also stores the trusted | |
| | relationships (paired Card/Tokens) | |
| | with their relevant privileges. | |

FIG. 11 discloses four main sources of data, one that exists in the back-end processor 1110 and three that exist on the trusted card/token 1120. Back-end processor 1110 contains the card application key store. Trusted card/token 1120 includes the card application transaction database, the card application records database and the card application master database.

The card/token application key store contains records of certificates that are capable of decrypting the protected card/token application records. The certificate thumbprint is used to uniquely identify the certificate, and thus the card/token user, that can decrypt the data. The key store record is related to the transaction by the unique TransId. Importantly, the key store is located on the trusted system server and not on the trusted card/token for security reasons. This also means that the trusted card/token is online and the user is authenticated and authorized in order to access the key store and read or write data to or from the card/token.

The card/token application transaction database contains metadata for a specific entry into the card/token application records database. The metadata stored in the transaction data store are used for identifying, filtering and searching of entries in the card/token application records database without decrypting the records. Metadata that is searchable from the application is promoted to the metadata level. Every record in the card/token applications records database is linked to a transaction by using the unique TransId.

The card/token application records database contains the content records for any structured or unstructured data that is stored on the trusted card/token. The content is encrypted and linked to the card/token application transaction database via the TransId.

The card/token application master database contains master data that is used to run the card/token application. Master data references can be stored as part of records stored in the card/token application records database. This database is synchronized with master data from the trusted system server.

The following tables describe key data elements in the card/token application key store, the card/token application transaction database, the card/token application records database and the card/token application master database.

The card/token application key store is as follows:

| Data Source | Data Element | Description |
|---|---|---|
| Card/Token | TransID | Transaction ID of the record. |
| Application | | Linked to the transaction |
| Key Store | | table |
| Card/Token | Encryption Type | Type of encryption used |
| Application | | to encrypt the record |
| Key Store | | |
| Card/Token | Proxy Certificate | Thumbprint of the |
| Application | Thumbprint | certificate used to encrypt |
| Key Store | | the symmetric key. This is |
| | | to identify the certificate. |
| Card/Token | Encrypted Symmetric | This contains the symmetric key |
| Application | Key | used to encrypt the record |
| Key Store | | content. The symmetric key is |
| | | encrypted using the proxy |
| | | entity's certificate. |

The card/token application transaction database is as follows:

| Data Source | Data Element | Description |
|---|---|---|
| Card/Token Application | ID | Unique transaction ID used |
| Transaction Database | | to identify transactions and |
| | | links to PHR data records. |
| Card/Token Application | Type | This is used to filtering and |
| Transaction Database | | searching of PHR records. It |
| | | contains the transaction |
| | | type, e.g., Doctor Visit |
| Card/Token Application | Date Time | Date and time at which the |
| Transaction Database | | transaction occurred |
| Card/Token Application | Meta Data | Metadata used to search and |
| Transaction Database | | filter the records |
| Card/Token Application | Signed Hash | Hash of the transaction |
| Transaction Database | | signed by server. This is |
| | | used to identify if a record |
| | | has been tampered. |
| Card/Token Application | Encrypted | Boolean to identify if the |
| Transaction Database | | transaction is encrypted. |

The card/token application records database is as follows:

| Data Source | Data Element | Description |
|---|---|---|
| Card/Token Application | TransID | Transaction ID of the PHR |
| Records Database | | transaction. Linked to the |
| | | Transaction table. |
| Card/Token Application | Data Record | Content relevant to the |
| Records Database | | specific PHR element. This |
| | | is elaborated in the database |
| | | design phase. |

The card/token application records database is as follows:

| Data Source | Data Element | Description |
|---|---|---|
| Card/Token Application | Data Record | Content relevant to the |
| Master Database | | specific Meta Data element. |
| | | This is elaborated in the |
| | | database design phase. |

In a Trusted Medical System embodiment, there are various relationships between the trusted system data elements that are used for authentication and authorization. A card/token element contains a record containing the details of a physical card/token. A user card/token element can be a patient card/token or a doctor card/token. The patent card/token element is a card/token that represents the records of a patient and is linked to roles associated with the specific user type. A doctor card/token element contains the record of a doctor and is linked to roles associated to the specific user type. A links element contains specific privileges that are granted to a proxy user. These can be via roles or specific privileges. A roles element contains a hierarchal grouping of privileges and is linked to a user type. A privileges element contains privileges that are the lowest level functions a user can perform on the card/token application.

A card/token is related to a user card/token element where every card/token is associated to a user. A user can be registered to more than one card/token. However, a card/token can only be registered to one or no users.

A patent is related to a doctor element when a trusted relationship has been setup between card/tokens and therefore the users that hold the card/token, a set of privileges are associated to the link. These privileges determine the functions that can be performed on the Patient Card/Token by the Proxy User. The privileges are inherited from the privileges assigned to roles of the Proxy User. The Patient Card/Token holder can then alter these privileges if required.

### The Trusted Medical System

The Trusted Medical System (“TMS”) is an embodiment of the secure transaction authentication system described in this application. TMS is directed to improve the overall quality of care while providing more efficient administration processes and combating several different forms of fraud, including identity fraud, patient fraud, and provider fraud. TMS is designed to address the issues plaguing the Medicaid system to include insecure data protection and authorization measures, fraud and inefficiency and ultimately, cost expansion.

TMS is a portable, interoperable, secure means of storing, transferring, exchanging and presenting patient medical information and treatments across multiple health care providers and facilities. The system includes comprehensive software that can store a user's data, as well as interface with existing web-based systems securely. Providing patient security and interoperability, the System is a bridge technology between (i) personal and operational health records, including multiple diverse Electronic Health Records (EHR) and Electronic Medical Records (EMR), (ii) local and cloud storage of patient information, and (iii) regional and integrated health information exchanges.

The System uses a memory token with an exterior surface that can utilize any number of identifying characteristics—address, signature, photograph, watermarks, or magnetic stripes. The System's token can take different form factors (e.g., USB devices, partition memories, SD Cards, smart phones, tables, mobile phones, smart watches, etc.) and creates a fundamental difference between itself and a typical Smart Card by creating a virtual machine independent environment, a critical factor for implementations across diverse environments and managing such a system. The token is essential to providing security which provides a non-refutable “electronic identity” using a permanent chip specific identity key assigned during manufacturing to administrators, service providers and patients.

TMS establishes a “trusted transaction” that certifies both the provider and beneficiary by confirming identity, certifications, eligibility, location, and length of service. TMS tracks a specific protocol across the “continuum of care” providing the reduction in duplicate services and rapid access to integrated medical systems/records that enables proactive intervention models to be undertaken, resulting in better healthcare and a reduction of overall cost.

TMS is designed to quickly and efficiently ensure that all eligible State Medicaid Program members and other State services (e.g., CHIP, Medicare, FFS, State health plan, etc.) receive better quality of care while increasing overall efficiency and reducing costs.

The TMS process assumes the State Medical Management Information System (MMIS) or Eligibility Database is the “record of truth.” The MMIS and Eligibility Database updates records nightly or in real-time to the Secure Exchange Policy Server. The Trusted Medical System uses a Federated Identity Model to establish identities and grant policies to beneficiaries and providers. The State is a Medicaid Registration Authority and issues the initial TMS token to patients and medical service providers.

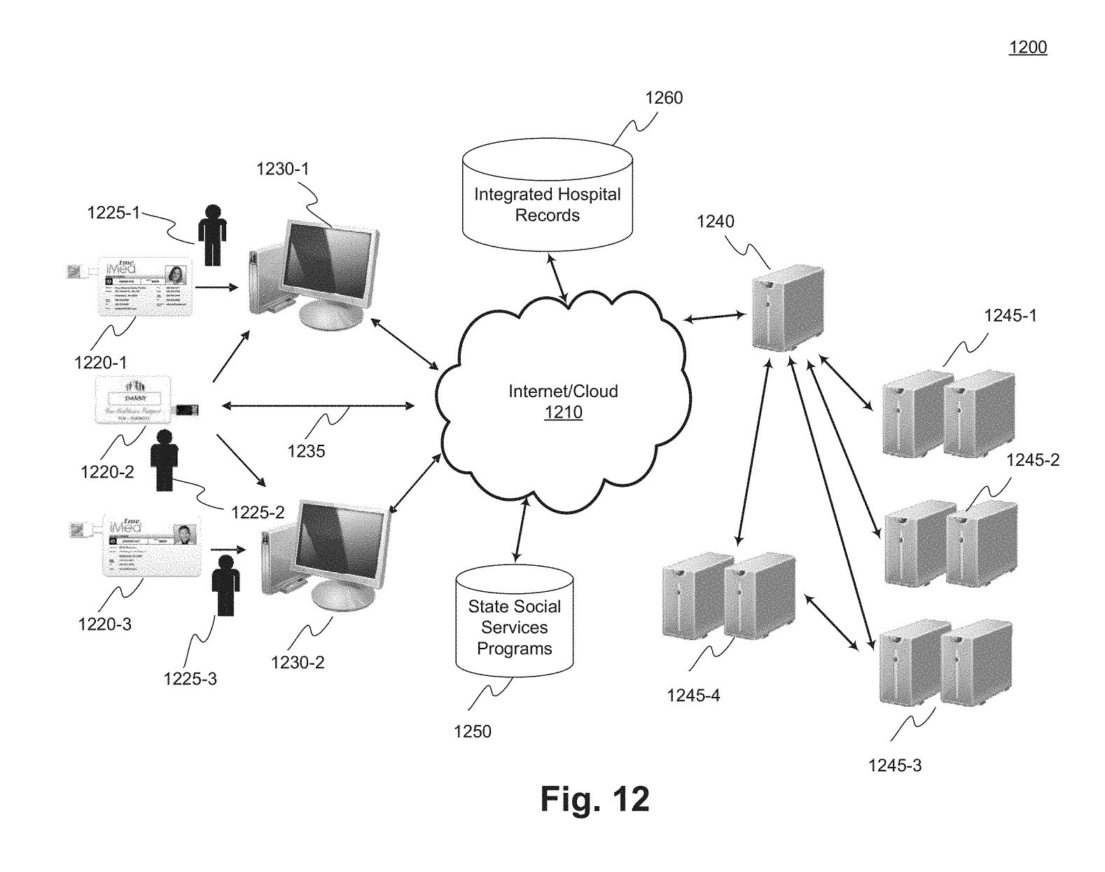

FIG. 12 illustrates a trusted medical system 1200, according to an embodiment. As an overview of the process, when a beneficiary seeks medical care, he or she presents the TMS token to a medical service provider. The provider inserts their own card, as well as the beneficiary's card, into a point-of-service device to access the patient's biometric data encrypted on a TMS policy server.

Once both cards are inserted, the TMS generates an authorization code and a reference date/time stamp that is stored both on the policy server and, in the case of our TMS card, on the card as well. This stamp documents the time the beneficiary's appointment began with the provider. Upon completion of the medical appointment, the beneficiary checks out, using the same two cards, multi-factor authentication process, creating a service visit duration time stamp. This record documents the duration of the medical service appointment.

Trusted medical system 1200 includes the Internet/cloud 1210, hardware based tokens 1220-1, 1220-2 and 1220-3, users 1225-1, 1225-2 and 1225-3 and policy server 1240. Trusted medical system 1200 also illustrates multiple workstations 1230-1, 1230-2 and 1230-3 and other servers such as 1245-1, 1245-2, 1245-3 and 1245-4. Trusted medical system 1200 also includes access to state social services programs 1250 and integrated hospital records 1260.

In an embodiment, user 1225-1 is a primary care physician and workstation 1230-1 is a medical records server. User 1225-3 is a hospital employee and workstation 1230-2 is an emergency room access system. User 1225-2 is a patient that can access and maintain their own medical records form either their hardware based token 1220-2 or directly through path 1235 through Internet/cloud 1210, or they can request transactions with either the primary care physician at workstation 1230-1 or through the emergency room workstation 1230-2.

In an embodiment, server 1245-1 can be an encrypted vault backup server, server 1245-2 could be a Center for Disease Control bio-surveillance server, and server 1245-3 could be a risk analysis server or a Medicaid management information system. Server 1245-4 could be a managed care organization eligibility benefit server. Trusted medical system 1200 operates in much the same way as described as trusted system 300, but applied in a medical system environment.

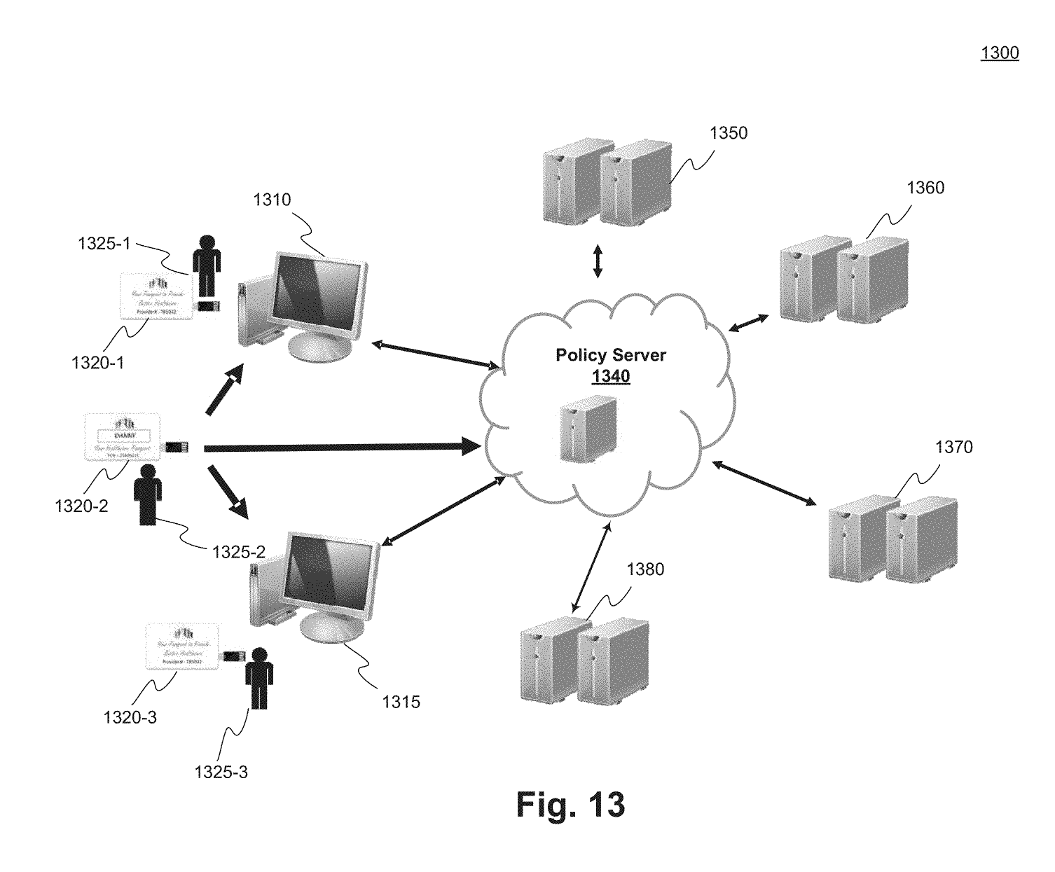

FIG. 13 illustrates a trusted medical system 1300, according to an embodiment.

Trusted medical system 1300 is directed to a primary care physician focused model. Trusted medical systems 1300 includes a policy server 1340, tokens 1320-1, 1320-2 and 1320-3 (hardware based), users 1325-1, 1325-2 and 1325-3. Trusted medical system 1300 also illustrates multiple workstations 1310 and 1315, and other servers such as 1350, 1360, 1370 and 1380.

In an embodiment, user 1325-1 is a primary care physician and workstation 1330-1 is a medical records server. User 1325-3 is a hospital employee and workstation 1330-2 is an emergency room access system. User 1325-2 is a patient that can access and maintain their own medical records form either their hardware based token 1320-2 or to policy server 1340, or they can request transactions with either the primary care physician at workstation 1330-1 or through the emergency room workstation 1330-2.

In an embodiment, server 1350 can be an encrypted patent healthcare vault server, server 1360 could be a managed care organization plans database server for case management, server 1370 could be a managed care organization eligibility and benefit server, and server 1380 could be a state health information exchange. Trusted medical system 1300 operates in much the same way as described as trusted system 600, but applied in a medical system environment.

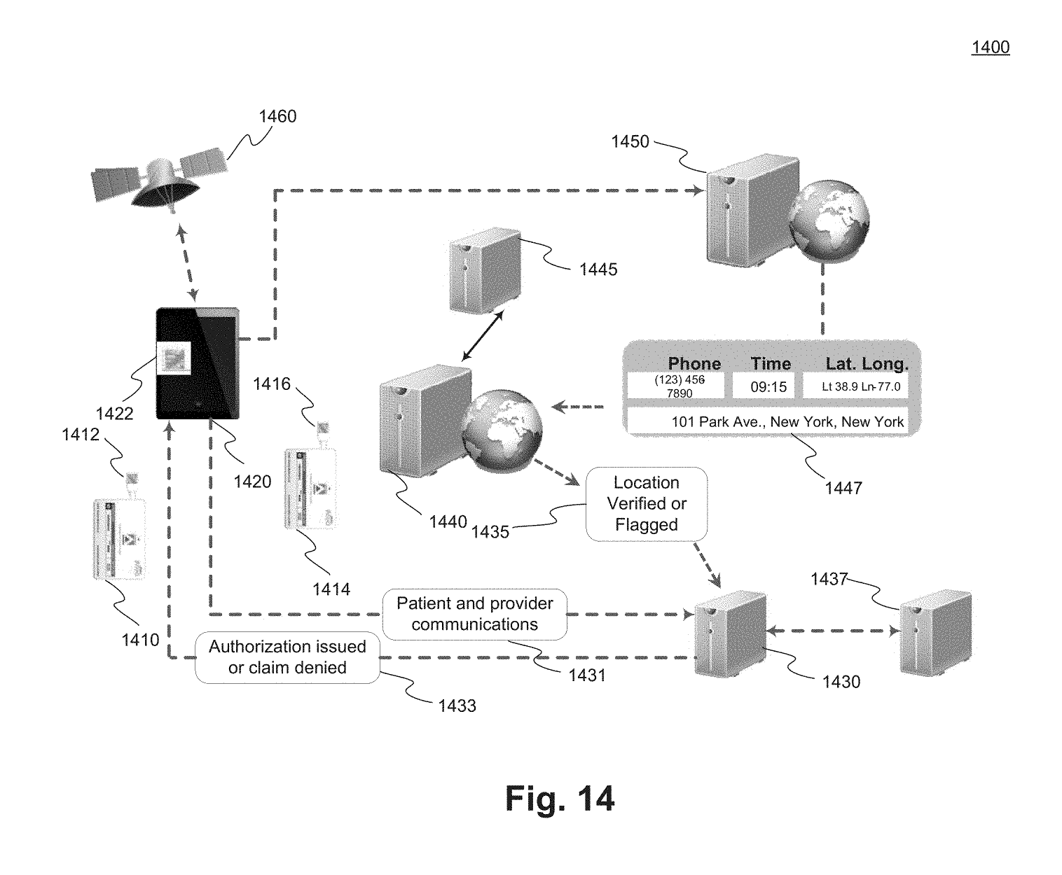

FIG. 14 illustrates a trusted medical system 1400, according to an embodiment. Trusted medical system 1400 is directed to a home healthcare environment. Trusted medical system 1400 enables the delivery of home healthcare that starts with centralized appointments and primary allocation of work opportunities to the highest-rated performers. Trusted medical system 1400 includes a patient hardware based token 1410 with a token chip 1412, a provider hardware based token 1414 with a token chip 1416, a portable electronic device 1420 with a device chip 1422, a trusted medical server 1430, an analytics engine 1440, a medical management information system 1445, a GPS location database server 1450, a global positioning system (GPS) satellite 1460.

GPS location database server can generate a GPS log entry 1447 that is sent to analytics engine 1440, which determines whether the location is verified or flagged at 1435 and that result is passed on to trusted medical server 1430. Trusted medical server 1430 also receives patient and provider communications 1431 from portable electronic device 1420 and based at least on the location data will either authorize or deny a claim at 1433. Trusted medical server 1430 also has access to a state eligibility database 1437 that can be used in the determination of whether to authorize or deny a claim.

Home healthcare utilizes multiple steps in a streamlined process to deliver and control health services. These steps include setting an appointment, allocating resources, timely reporting of all rendered services, the actual delivery of services and post appointment processing.

Healthcare services typically begin when the patient or a provider initiates a demand on the delivery system for an appointment or possibly a sequence of particular services by a provider. For example, when a doctor orders specific physical therapy and nursing services following a hospital stay to replace a hip or some similar “trigger” event, the system receives a demand for service.

In order to achieve and maintain the offered range of benefits while minimizing fraud, the paying organization needs to control the process beginning-to-end. The Appointment step is the entry funnel to the process with several considerations:
what services are available;
when can these services be delivered;
which providers are qualified to deliver what specific services;
how are providers evaluated (their performance rating) and incentivized; and
what is the week-to-week availability of each provider.

The above elements define the size of the appointment funnel and the resources available to meet the demands at any time.

The next important step in preparation is allocation of qualified resources available for each appointment demand. Ideally, this is a computer-driven, auto-executing, allocation process. Steering this allocation process is the “rating” of each provider. Other elements also contributing to guiding of the allocation are somewhat simple and mechanical. These elements are as follows
specific services each provider is qualified and authorized to deliver;
availability (provider submits weekly);
location proximity to the scheduled patient's location; and
a tie-breaking method (random number generator prioritizing equally-qualified providers).

The above elements are more or less essential for an orderly allocation process. However, any well-functioning process also needs an ability to evolve and continuously improve. The humans performing these services also deserve incentives to stay focused and drive their personal performance.

The allocation process is neutral and balanced. Each provider is treated equally. The providers own personal performance ratings are the sole variable for adjusting individual performance ratings. Four objective values are measured for calculating a rating along with one subjective measure. The objective values include:
calling the patient 15 to 30 minutes before arriving for the appointment as a courtesy to the patient;
following formal policies and procedures and delivering industry “best practices”;
accuracy and timeliness when self-reporting on services delivered; and
accuracy and timeliness of invoice billing for these delivered services.

The one subjective area of evaluation is provided by the patient. The patient can be asked to offer a brief evaluation of the service delivered. An evaluation that is higher or lower than typically given, may lead to additional follow-up performance review questions.

Occasionally, the healthcare system may be randomly sampled for service delivery performance. Special follow-up surveys may also be conducted to investigate revising practices or if issues are discovered with delivery execution.

Clearly, execution excellence is the process goal. Provider performance is a key criterion to an overall score for an insurance provider. Each provider has almost total control over their own evaluation. The best performing providers will gain an edge.

One objective measure of execution is preparing and issuing timely reports for each service delivered. Management can broadly monitor on-going home healthcare service execution daily using these provider reports. Generally, reports document in brief statements the services delivered. Rapid invoicing and timely payments for audit-certified delivery is equally important to this streamlined execution process.

The brief Timely Activity Report (TACREP) is begun upon arrival at the patient's residence. This brief report includes start time, location, patient identity, specific services planned, confirming patient eligibility and authentication, reporting on the actual services delivered, any appropriate remarks, and the time of appointment completion. Following transmission of this TACREP, the provider then quickly invoices for delivered services.

Delivery of services informally begins when the provider considers what type of service this patient will require and an optimum route to the patient's residence. The next day, the provider calls and advises when the provider will arrive at the patient's residence. The delivery process formally begins by initiating a Timely Activity Report. At the front entrance of the residence the provider captures the GPS location before signaling arrival (knocking or ringing).

The provider greets the patient upon entering and immediately begins setting-up and preparing for the service while making light conversation with the patient.

An essential step is for the provider to log-in to trusted medical system 1400. Next, the patient's eligibility for Medicaid services is again checked. If as expected, the patient is eligible, it is time for the patient to log-in. The provider authenticates the patient log-in and now it is time for service delivery. Both patient hardware based token 1410 with token chip 1412 and provider hardware based token 1414 with token chip 1416 remain plugged-in to portable electronic device 1420 for the duration of the service delivery to enable persistent GPS authentication.

Depending on the type of service, the steps, duration, amount of fact-finding discussions and documentation will vary. The provider has the time and tools to accomplish an excellent service visit. When the delivery is concluded, the provider returns to finish the Timely Activity Report documenting services delivered plus any appropriate findings/remarks. Departing the residence, the provider completes and sends the Timely Activity Report and the service Invoice before focusing on the next patient's appointment. Meanwhile, management has the opportunity to remotely obtain a limited awareness of execution flow as the day progresses. The receipt of TACREP's and invoices shortly after each completed visit document execution as the delivery day progresses.

The paying organization performs a more detailed analysis and auditing once activity and billing reports are pre-processed. It is during this processing that critical comparisons of planned vs. actual and other execution details are closely examined. Fine-grained analysis of statistical results may indicate “model” performers as well as curious performance deviations and irregularities.

When pre-processing is complete certain results may trigger specific kinds of follow-up action. For example, if necessary, the patient may be called for a routine quality control evaluation or may even be visited for a special quality control assessment. Any irregularity in the reporting profile will be examined by an auditor. As a result of this analysis, a provider may be called to discuss policy, procedures, or practices. Subsequently, the provider may be required to repeat a segment of training, or even suspended. Any infraction of a serious nature that is verified may result in immediate termination.

The auditing and quality control teams require independence if not near-anonymity from the providers. The system's continuing performance integrity requires an ability to detect and stop in any form a “gaming” of the system as well as any potential for fraud.

Trusted medical system 1400 is configured to support and deliver health care services utilizing the above steps. For example, trusted medical system 1400 includes portable electronic device 1420 with device chip 1422, in conjunction with patient hardware based token 1410 with token chip 1412, and provider hardware based token 1414 with token chip 1416, and allows for the gathering of patient and provider information that is sent to trusted medical server 1430 that validates identities and validates eligibility. Trusted medical server 1430 can then download permissions and healthcare information back to portable electronic device 1420 that can record the time and location of service, provide up to date eligibility, provide a length of service and also provide an updated report on service.

Portable electronic device 1420 also receives GPS location data from GPS satellite 1460 where the location data is sent to GPS location database server 1450 that stores a listing of electronic device locations, e.g., portable electronic device 1420 location, and can store that information including address locations and times. Further, portable electronic device 1420 can also be programmed to send a series of GPS locations to GPS location database server 1450 based on a threshold time interval, movement, or a request from GPS location database server 1450, analytics engine 1440 or trusted medical server 1430.

GPS log entry 1447 is sent to analytics engine 1440 that monitors the eligibility of any providers and the patients. Analytics engine 1440 also verifies the services to be provide including the verification of patient and provider location and a determination of an allocated length of time of a visit based on the services provided. Analytics engine 1440 also has access to medical management information system 1445 in making any determinations and also either verifies the locations received as being valid or flagging them for further analysis or denial of services.

### CONCLUSION

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

We claim:

1. A secure electronic transaction system comprising:
a hardware based token comprising a manufactured identity key;
a public/private key pair linked to a user and the hardware based token; and
a policy server configured to be communicatively coupled to the hardware based token;
wherein the hardware based token contains biometric identification data of the user,
wherein the policy server is configured to provide authentication of the user based on:
a possession of the hardware based token by the user;
a matching of the manufactured identity key with a priori registered key stored on the policy server;
the public/private key pair;
a user password; and
the biometric identification data.

2. The secure electronic transaction system of claim 1, wherein the biometric identification data comprises a picture of the user.

3. The secure electronic transaction system of claim 1, further comprising a federated identity model comprising a plurality of domains.

4. The secure electronic transaction system of claim 1, wherein the authentication comprises a setting of user permissions.

5. The secure electronic transaction system of claim 4, wherein the setting of user permissions include allowing the user to access data on the hardware based token or from an encrypted cloud connection.

6. The secure electronic transaction system of claim 1, wherein the authentication is based on a third-party confirmation of the biometric identification data of the user.

7. The secure electronic transaction system of claim 1, wherein the hardware based token is configured to digitally sign a user's access to data stored on the hardware based token.

8. The secure electronic transaction system of claim 1, wherein the hardware based token further comprises a processor and partition memory configured to run a virtual machine environment.

9. The secure electronic transaction system of claim 1, wherein the hardware based token further comprises an encrypted database.

10. The secure electronic transaction system of claim 1, wherein authentication further comprises receiving a series of global positioning system locations that are compared to an expected global positioning system location.

11. A method for conducting secure electronic transactions, the method comprising:
communicatively coupling a hardware based token with a policy server, wherein the hardware based token contains a manufactured identity key;
receiving, by the policy server, the manufactured identity key;
receiving, by the policy server, a public/private key pair linked to a user and the hardware based token; and
authenticating the user based on:
a possession of the hardware based token by the user;
a matching of the manufactured identity key with a priori registered key stored on the policy server;
the public/private key pair;
a user password; and
biometric identification data of the user.

12. The method of claim 11, wherein the biometric identification data comprises a picture of the user.

13. The method of claim 11, wherein the authenticating further comprises a setting of user permissions.

14. The method of claim 13, wherein the setting of user permissions include allowing the user to access data on the hardware based token.

15. The method of claim 11, wherein the authenticating further comprises a third-party confirmation of the biometric identification data of the user.

16. The method of claim 11, further comprising running a virtual machine environment on the hardware based token.

17. The method of claim 11, further comprising accessing an encrypted database on the hardware based token or from an encrypted cloud connection.

18. The method of claim 11, wherein authenticating further comprises receiving a series of global positioning system locations that are compared to an expected global positioning system location.

19. The method of claim 11, further comprising communicatively coupling a second hardware based token with the policy server, wherein the second hardware based token contains a second manufactured identity key;
receiving, by the policy server, the second manufactured identity key;
receiving, by the policy server, a second public/private key pair linked to a second user and the second hardware based token; and
authenticating a second user based on:
a possession of the second hardware based token by the second user;
a matching of the second manufactured identity key with a priori registered key stored on the policy server;
the second public/private key pair; and
biometric identification data of the second user.

20. The method of claim 19, further comprising paring the user and the hardware based token with the second user and the second hardware based token.
